(19) United States
(12) Patent Application Publication
(10) Pub. No.: US 2007/0296545 A1
(43) Pub. Date: Dec. 27, 2007

(54) SYSTEM FOR MANAGEMENT OF UBIQUITOUSLY DEPLOYED INTELLIGENT LOCKS

(75) Inventor: Thomas J. Clare, Media, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CHECKPOINT SYSTEMS, INC., Thorofare, NJ (US)

(21) Appl. No.: 11/781,642

(22) Filed: Jul. 23, 2007

Related U.S. Application Data
(63) Continuation-in-part of application No. 11/609,148, filed on Dec. 11, 2006.
(60) Provisional application No. 60/750,194, filed on Dec. 14, 2005.

(51) Int. Cl. E05B 47/00

(52) U.S. Cl. 340/5.64

(57) ABSTRACT

A lock system having a remote actuating key device, e.g., a portable member arranged to wirelessly transmit a wireless signal, and a passive lock device for receiving that signal. The lock device includes an actuatable trigger mechanism and a control circuit. The control circuit receives the wireless signal, which powers it. The control circuit also determines if the wireless signal is appropriate to unlock the lock, whereupon it produces a trigger signal. The trigger mechanism is responsive to the trigger signal to actuate and enable the lock device to be opened. The key device is also arranged to communicate via a wireless communications connection to a computer network. The communication with the computer network may carry commands and information. The key device may relay communications between the lock device and the computer network.

### CROSS-REFERENCE TO RELATED APPLICATIONS

This continuation-in-part application claims the benefit under 35 U.S.C. § 120 of utility application Ser. No. 11/609,148 filed on Dec. 11, 2006 entitled Systems and Methods for Providing Universal Security for Items, which claims the benefit under 35 U.S.C. § 119(e) of provisional Application Ser. No. 60/750,194 filed on Dec. 14, 2005 also entitled Systems and Methods for Providing Universal Security for Items and both of whose entire disclosures are incorporated by reference herein.

### BACKGROUND OF THE INVENTION

1. Field of Invention

This invention relates generally to security systems and more particularly to locks, locking systems and methods for protecting items via locks and for providing access control via locks.

2. Description of Related Art

The protection of products from theft anywhere in the retail supply chain from the manufacturer to the retailer is a major concern and a multibillion dollar market. This theft, or product “shrinkage”, can be by members of public at large and/or by employees of the business. In fact, employee theft is likely to be a greater problem than thefts by others. To address the product shrinkage issue, various security approaches are in use alone or in combination with one another.

For example, electronic video surveillance is a common technique employed to deter theft. While generally suitable for their intended purposes, such systems are not without their drawbacks. In this regard, such systems are relatively expensive. Moreover, and quite significantly for maximum utility, they are labor intensive, i.e., they operate best if a human being is present at the video terminals to constantly monitor the video received from the various cameras, since that is the only way to detect the theft as it is occurring. While many businesses do make use of video surveillance cameras, due to financial restraints they may not be able to provide staff to constantly monitor the cameras. Instead, many retail businesses merely rely upon videotape or digital systems to record the events for review later, e.g., after a theft incident has arisen. While that approach may result in determining the identity of the perpetrator of the theft, it does not prevent the theft.

Other systems for preventing theft in use today entail the use of security tags on the items to be protected. For example, in the retail environment, e.g., a store, it is a common practice to tag the items to be sold with an EAS (electronic article surveillance) tag or an RFID (radio frequency identification) tag to ostensibly prevent that item from being pilfered. Some types of EAS tags comprise a sticker or label including a deactivatable resonant circuit which, if not deactivated when the tagged item is paid for and checked out, will cause an alarm signal to be produced when the item bearing the tag is brought past an antenna system at the exit of the store. Deactivation of many types of EAS tags is typically accomplished by the application of a high voltage signal to the tag's resonant circuit at the checkout counter to prevent it from resonating in the field of the antenna system.

Other EAS tags may be in the form of what are called “hard tags.” A hard tag can be thought of as being closely related to a lock since it basically comprises a device which is releasably secured onto the item to be protected, so that it is resistant to removal, and which includes means that will produce an alarm when the tag is brought past the antenna system at the exit of the store if the tag has not be removed from the item. Hard tags typically include a plastic housing made up of two cooperating housing components which together form an actuatable locking mechanism. In a common implementation, one component contains a pin and the other component a magnetically operated, spring loaded ball clutch. The pin of the one component is arranged to be pressed through a portion of the item to be protected and inserted into the clutch of the other component. The clutch is arranged to hold the pin until an externally applied magnetic force releases opens the clutch, thereby releasing the pin. The unlocking of a magnetically actuated locking mechanism is typically accomplished by the check-out clerk bringing the hard tag to a location at the checkout counter where a powerful magnetic field is generated to release the clutch. Thus, the hard tag can be removed from the item to be sold, so that when the item is carried past the antenna system at the exit of the store, there is no tag on the item to set off an alarm.

Other devices for releasable (e.g., lockable) attachment to an item to be protected are so called “safers” and “spiders.” One example of a safer is shown in copending U.S. patent application Ser. No. 11/154,252, filed on Jun. 16, 2005, entitled Self-Check System and Method For Protecting Digital Media, which is assigned to the same assignee as this invention and whose disclosure is incorporated by reference herein. The safer shown therein is merely exemplary of various types of safer devices that the subject lock system can be used with. A “spider” basically comprises an alarm tag with one or more retractable cable lanyards by which it is affixed to merchandise to be protected. See for example U.S. Pat. Nos. 5,722,266 (Yeager et al.) and 5,794,464 (Yeager et al.).

While the foregoing EAS and RFID tag systems are generally suitable for their intended purposes, they still leave much to be desired from the standpoint of effectiveness. For example, many prior art EAS/RFID systems are particularly susceptible to avoidance by employees of the store, e.g., the employees may remove or otherwise disable the tag. One particular avoidance scheme is known as “sweet-hearting.” In the context of deactivatable EAS tags, such action can be accomplished by the checkout clerk deactivating the tag on an item, but not ringing up the sale on the register, so that the item can be taken from the store without producing an alarm. For hard tags, sweet-hearting can be accomplished by the check-out clerk placing the hard tag within the magnetic field to release the clutch and thereby enable the tag to be removed, but not ringing up the sale.

To minimize the chances of sweet-hearting of items to be protected with hard tags, so-called “authenticated detachment” systems have been proposed. One type of system is that disclosed in U.S. Pat. No. 7,242,304 (Clancy, et al.), entitled System and Method for Authenticated Detachment of Product Tags, which is assigned to the same assignee as this invention and whose disclosure is incorporated by reference herein. Such authenticated detachment systems basically comprise hard tags including an RFID circuit. The magnetic detacher, i.e., the device that magnetically releases the ball clutch of the tag, includes an RFID reader. Such a system can be operated so that it will only permit the detacher to release the tag (or prevent the system from setting off an alarm if the tag remains on the item) if the tag is read into the register or the store's computer system.

Avoidance of tag detection systems can also be achieved by use of various types of anti-detection devices, depending upon the type of security tag used. For example, if the tag is in the form of a label or sticker including a resonant circuit, some thieves may make use of metal-foil-lined bags into which the tagged pilfered merchandise can be placed so that the electronic system for detecting the tag is unable to do so. If the tag is a hard tag, some thieves may make use of a powerful magnet which they carry to release the clutch mechanism of the hard tag to permit them to remove the hard tag before they attempt to take the item out of the store.

Another commonly used technique used to protect items from theft is to lock particularly susceptible items, e.g., small, high-value items, in a pilfer-proof environment, e.g., in a cage or some other secure structure within the retail establishment. While the use of a locked environment has some advantages from a security standpoint to reduce theft, it has various disadvantages from a merchandising standpoint. In particular, the use of a locked, restricted environment may impede the sales of the item by making it difficult for consumers to put their hands on the item to examine it. Moreover, the use of locked environment for items to be sold presents various complications and concomitant problems resulting from the inherent need for keys, particularly physical keys, to unlock the secure environment(s) where the items are held. The same holds true for items to be protected during transportation, e.g., by truck containers from the warehouse to the retail establishments.

Among the various issues that may impede the merchandising of the items stored in locked environments are the following. Are different items to be stored in different secure areas, each with its own key, or will a common key be used? Which employees are to be given the key(s) to the lock(s)? As will be appreciated, if only the manager is given the key in the interest of security, this can significantly impede sales since many store patrons may not be patient enough to wait until the manager is available to unlock the area to provide access to the items. Other issues and problems inherent with use of physical keys are: what procedure will be followed if a key is lost or stolen? Does (do) the lock(s) have to be changed immediately? If so, is access to the protected area to be off limits to customers until the lock is changed? The same also holds true with respect to items locked in containers, totes or other transportable or static storage devices. For example, with respect to truck containers, will all of the truck containers in the business's fleet have to be brought in for changing the container locks if a key is lost or stolen? These are but a few examples of the problems associated with merchandising products that are stored in locked or secured areas or containers, etc. The elimination of a physical key and its substitution with an electronic key for providing authorized opening signals to an electronically operated lock having some intelligence built into it to recognize an appropriate opening signal can eliminate or minimize some of these merchandising issues, but not all.

The use of RFID reader technology has been disclosed for effecting the opening of locked items. For example, in U.S. Pat. No. 6,957,767 (Aupperle et al.) there is disclosed a mailbox equipped with an RFID reader that is arranged to be powered by a battery or by an electrical line connected to the mailbox. An RFID tag is also provided to continuously transmit a signal which contains an RF identifier. Upon receipt of that signal the RFID reader compares the RF identifier in the signal to an RF identifier assigned to the mailbox. If a match is established, the mailbox is unlocked and access is permitted. The signal transmitted may be encrypted for security. See also, Published United States Patent Application US2005/0156752A1 (Finkenzeller et al.) which discloses as system making use of transponder to send a wireless signal to a device that is arranged to control the opening of a door. That device includes a small battery to power it. When the appropriate signal sent by the transponder is received, the device unlocks the door. While the forgoing lock systems may appear generally suitable for their stated purposes, they require on-board power, e.g., a battery, for the unlocking device to operate, a less than optimal solution.

Similarly, a variety of other intelligent electronic locks has been described in patents, such as U.S. Pat. No. 6,604,394 (Davis), which avoid some costs associated with the management of physical locks. However, absent a network connection from the lock to a central control, such intelligent locks require a great deal of manual labor, and the goodwill of its operators, to be properly maintained. They are therefore similarly problematic for ubiquitous intelligent lock deployments.

Today, despite the introduction of such intelligent lock devices, conventional physical locks and keys are still the default method of securing doors, items, and controls in homes, retail, military, medical and other and commercial and non-commercial facilities. Mechanical locking technology improved rapidly in the 19th century with the development of interchangeable parts for pin-tumblers as described in U.S. Pat. No. 48,475 (Yale). Innovation continues today with advances such as replaceable core set re-pinning, as described in U.S. Pat. No. 6,021,655 (Labbe). However these improvements do not address or overcome all the problems noted above.

Nor are these problems solved by EAC (electronic access control) systems such as that described in U.S. Pat. No. 4,727,369 (Rode). Various intelligent locks exist which are meant either to enhance the security of physical locking devices, such as vaults, to avoid costly re-keying of conventional pin-tumbler or replaceable core locks, or to achieve rapid electronic reporting and control of privileges. These systems use relatively low cost identification cards as keys and relatively expensive card reader and lock controllers. While flexible and powerful, due to cost these systems are inappropriate for ubiquitous lock deployments. Where there are to be many locks and few keys, conventional EAC, intelligent lock, and RFID systems are not economically feasible.

In many environments it is highly advantageous that a user possess a single key device that can access many or all the lock devices that the user is properly allowed to access. The user would not need to carry different keys for different locks. Similarly, it is highly advantageous that those in charge of a facility maintain a complete record of both the proper uses of keys and of the improper attempted uses. It is further highly advantage that those in charge of a facility be able to quickly, ideally automatically, change or otherwise control which key devices may access which lock devices. Ideally, such advantages would be available in a single system which encompasses a wide variety of lock formats including, at one extreme, strong, fixed lock devices as may be found on vaults or entrance doorways, and, at the other extreme, small, inexpensive, and possibly disposable formats which are portable and not normally connected to either power sources or communications networks.

In the past, universal keying and low cost were achieved through simple mechanical solutions such as mechanical solutions such as simple magnetic locks. Universal observation and control were achieved by EAC systems. No system achieved both sets of features simultaneously.

With digital and network technology, it is possible to both uniquely identify users and to communicate to facilities globally where each user should be granted access privileges. Solutions for how to securely manage and distribute such data is familiar to those in the information technology industry. The pivotal and perhaps unrecognized issue has been how to economically provide lock devices capable of receiving and acting upon such information. It is not practical, for instance, to use a $1,000 wireless EAC access point to secure a $3 pack of razors. Secure, sophisticated medium and long range wireless devices are still expensive, as is the alternative of pulling power and data wiring to each lock. However, it turns out that prior systems are based on improper assumptions regarding what is the proper or necessary distribution of functions among lock, key, and network devices.

The shortcomings of prior systems for managing controlled access to merchandise, facilities, and controls are overcome in the present invention by a variety of means. The invention provides a system which is very low in cost both to deploy and to maintain. At the same time, it provides automated monitoring and control of all access activities. It does so without compromising security, and in a way which allows unprecedented cooperation of various parties in the management of locked goods.

In order to overcome the above problems and drawbacks of the prior art, a universal lock and key management solution for preventing unauthorized access to merchandise, facilities, and controls is needed. Such a system would be a great value in retail, medical, military, lodging, and many of kinds of facilities. The subject invention addresses those needs.

All references cited herein are incorporated herein by reference in their entireties.

### BRIEF SUMMARY OF THE INVENTION

A lock system comprising: a remote actuating key device which comprises a portable member arranged to wirelessly transmit at least one radio frequency signal; a passive lock device which comprises an actuatable trigger mechanism coupled to a control circuit, and wherein the control circuit is adapted to receive the at least one radio frequency signal for electrically powering the control circuit; and for determining if the signal is appropriate to unlock the lock device. The control circuit also generates a trigger signal if the signal is determined to be appropriate, wherein the trigger signal is received by the trigger mechanism which activates the trigger mechanism to enable the lock device to be unlocked; and a computer network, wherein the computer network and the key device are adapted to communicate via a wireless communications connection (e.g., messages may be relayed by the key device between the lock device and the computer network).

A method of protecting a structure by use of a lock system comprising: (a) coupling a passive lock device to a structure for protecting the structure; (b) wirelessly transmitting at least one radio frequency signal from a remote actuating key device which includes a portable member; (c) receiving the at least one radio frequency signal by a control circuit of the passive lock device for electrically powering the control circuit; (c) determining, by the control circuit, if the at least one radio frequency signal is appropriate to unlock the passive lock device, and generating a trigger signal, by the control circuit, for receipt by an actuatable trigger mechanism coupled to the control circuit if the at least one radio frequency signal is determined appropriate and not generating the trigger signal if the at least one radio frequency signal is determined not appropriate by the control circuit; (e) enabling the lock device to be unlocked by the trigger mechanism when the trigger signal is received by the trigger mechanism; and (f) communicating, by the remote actuating key device, with a computer network via a wireless communication network (e.g., messages may be relayed by the key device between the lock device and the computer network).

In accordance with other aspects of this invention, access to the key device and lock device may be controlled through a variety of means including the execution of internal algorithms by the key device or lock device, input from the user of the key device, communications between the key device and the computer network, or combinations thereof.

### BRIEF DESCRIPTION OF SEVERAL VIEWS OF THE DRAWINGS

The invention will be described in conjunction with the following drawings in which like reference numerals designate like elements and wherein:

FIG. 1 is a schematic view of one exemplary embodiment of a locking system constructed in accordance with the subject invention;

FIG. 1A is a functional diagram of the lock shown in the exemplary embodiment of FIG. 1;

FIG. 1B is a functional diagram of the electronic key shown in the exemplary embodiment of FIG. 1;

FIG. 1C is a block diagram of an exemplary “smart card” core module that forms a portion of the on-board electronics for the electronic key and for the lock shown in the exemplary embodiment of FIG. 1;

FIG. 2 is an exploded view of a hard tag forming a part of an exemplary locking system, like that of FIG. 1, shown protecting a garment from theft;

FIG. 3 is an isometric view of a safer forming a part of an exemplary locking system, like that of FIG. 1, shown protecting a CD or DVD from theft;

FIG. 4 is a block diagram of various devices which may make use of the subject invention and showing various structures (static and portable/movable) for which the locking system of the invention can be used;

FIG. 4A is a block diagram of various devices which may make use of the subject invention and showing various controls (discrete setting, i.e., bi-state or poly-state; continuous setting; or data flow control) for which the locking system of the invention can be used.

FIG. 5 is a schematic representation of an exemplary embodiment of an access privilege control system constructed in accordance with one aspect of this invention and depicting the elements that may be involved in deploying the system in a retail facility;

FIG. 6 is an illustration of an exemplary embodiment of the key device;

FIG. 7 is a schematic representation of an exemplary embodiment of an access control system constructed in accordance with another aspect of the subject invention as implemented jointly with a prior art electronic access control system;

FIG. 8 is a schematic representation of an exemplary embodiment of the subject invention which uses a cellular telephony network to achieve ubiquitous deployment of intelligent locks by consumers;

FIG. 9 is a schematic representation of an exemplary embodiment of the subject invention in the form of a process for dynamically controlling user operation of key devices;

FIG. 10 is a schematic representation of an exemplary embodiment of the subject invention in the form of a process for dynamically controlling lock device and key device interactions;

FIG. 11 is a schematic representation of an exemplary embodiment of the subject invention in the form of a process for dynamically controlling the relocking of a lock device opened by a user of a key device; and

FIG. 12 is a table representing an exemplary embodiment of the subject invention depicting access credentials of lock devices and of key devices as may occur in a retail facility.

### DETAILED DESCRIPTION OF THE INVENTION

Before discussing the details of the preferred embodiments of this invention the following should be pointed out. In all aspects, the invention involves a lock device and a key device. Several optional configurations of each are described below. In addition, in many aspects the invention includes other devices in communication with key devices and/or each over network connections. The other devices perform a variety of functions alone or in combination with each other or in combination with the lock device and the key device as will be described below.

Herein the term “key device” refers to a portable member by which its holder may gain access to a lock device. Abstractly, a key device performs a function equivalent to an ordinary mechanical key that a person would carry to manipulate the lock on the front door of their home. A key device is a personal, portable way to demonstrate to the satisfaction of a lock device that the holder of the key device possesses sufficient authority to actuate the lock device. The key device of this invention, however, is not a simple mechanical key. It is rather primarily an electronic device. Normally it is self-powered, as by a rechargeable battery. It contains electronic means of communicating with a lock device, and may contain separate means for communication with a network. It is advantageous in many circumstances that both communication channels of the key device be wireless communication channels. Key devices could be small, single-purpose devices in the form of wands, watches, bracelets, pendants, placards, key fobs, or other easily carried items. Key devices could also include more complex user interfaces to resemble remote control devices. A key device could further be incorporated into a more sophisticated personal computing or communication device such as a cellular telephone, personal digital assistant, pager, laptop computer, or the like. Key devices could even been built into, or attached to, permanent fixtures or vehicles. However, they preferably take the form of a portable member that may be carried by an individual and applied wherever that user sees fit to do so.

Herein the term “lock device” refers to a lock which is arranged to communicate with a key device. Thus a lock device contains at a minimum one communication channel to receive information from, or conduct a dialogue with, a key device. The lock device may be arranged to function like an ordinary portable mechanical padlock having a robust housing and a bar which, when locked, cannot be dislodged from the housing. The lock device may alternatively be fixed onto a structure, e.g., in the manner of a door lock. The lock device may also alternatively be arranged as a secure control device, whereby actuation by a key device changes either the state of an electrical switch, such as a vehicle ignition, or changes an electrical or pneumatic control level, e.g., in the manner of a light dimmer switch or hot water valve respectively.

The lock device is preferably arranged to receive at least one signal from the key device wirelessly, e.g., at radio frequency. Whether configured as a mechanical interlock or as a locking control device, the lock device comprises an actuatable trigger mechanism, and a control circuit. The trigger mechanism, when actuated, enables either the mechanical interlock to be opened or the control device to be operated. Preferably, the control circuit is adapted to receive the at least one radio frequency signal from the portable member for electrically powering the control circuit. The control circuit is also arranged to determine if the at least one radio frequency signal is appropriate, whereupon the control circuit produces a trigger signal. The trigger mechanism is coupled to the control circuit and is responsive to the trigger signal to enable the mechanical interlock to be opened or the control device to be operated.

In accordance with another aspect of this invention a protection system comprising a lock system and a structure, e.g., a static structure or portable/movable structure, such as a container for holding one or more plural items, to be protected by a lock device is provided. The lock system is preferably constructed as set forth above.

In accordance with still another aspect of this invention a method for protecting a structure (e.g., static or portable/movable) by use of a lock system is provided. The method basically entails providing a lock system that is preferably constructed as set forth above and coupling that system to the structure to be protected.

To avoid the costs normally associated with the deployment of intelligent locking solutions, in several aspects the lock device of the invention does not require any additional connection or communications channel. Instead, optionally in a preferred embodiment, all needed power and communication transmission can come through the key device. Much of the cost of deploying traditional EAC systems is in the labor to run power and data wires to EAC badge readers. Wireless badge readers trade wireless hardware costs for data wiring, but still require power wiring, large batteries, or manual operation. It is even preferable, but not necessary, that the lock device should contain no battery, since batteries are a source of potential failure and often require routine maintenance.

A fundamental aspect of any access control system is how the use, misuse, and/or abuse of lock devices and key devices may be monitored. The present invention provides a method for achieving recording of key device events. This includes proper uses, as when a holder of a key device presents the key device to a lock device that the holder is authorized to access. It also includes improper uses, as when a holder attempts to access an unauthorized lock device. Since the lock device is not normally connected to a network, this reporting may instead be done through a key device which is connected to a network. Thus, automated visibility of key use and abuse may be achieved without a direct connection of the lock device to a network. This may happen at the time of the event. Alternatively, the data may be buffered for transmission at some later time. For security purposes, it is desirable that, in either case, this transmission should occur without requiring the consent of the key holder.

Of course, another fundamental issue for all access control systems is how changes in access privileges may be implemented. In EAC systems, changes in privileges are communicated over networks to terminal control devices that decide which badge holders will be allowed access at which times. In traditional mechanical lock and key systems, changing privileges is more problematic. Mechanical keys are easily stolen. Worse, they are easily duplicated. Thus recovering a mechanical key from an estranged associate is often regarded as insufficient. In such cases, each lock which is potentially affected by a security breach must be physically altered. Similarly, most intelligent locking systems also require human labor to reprogram each potentially affected lock in the field.

The present invention includes a variety of methods to effect the alteration of access privileges. The alteration can be accomplished either through methods for the management of the key device or through methods for management of the dialogue between the lock device and the key device.

There are four basic methods for managing the key device by itself which may be used singly or in combination. First, the key device could require a fixed password from a user. For example, a holder of a key device could be assigned a personal identification number (PIN) that will enable the key device. If the holder does not know the PIN, the key device will refuse to communicate with lock devices, but may report the failed activation attempt to the network.

Second, the key device could automatically permute the required password periodically. In other words, the password that worked for the first seven days will not work thereafter. This may be achieved by the key device itself, and not require any network connection. To use the key device, the user must acquire a new password periodically.

Third, a key device might be enabled or disabled by the issuance of a command from the network to the key. Such a command might be the result of an automatic operation or a user action. Optionally this could involve a dialogue with the network, i.e., a user may be prompted for a password that is known to the network but not necessarily to the key device itself.

Fourth, a key device might be arranged to enable or disable itself in accordance with an internally programmed set of rules including such factors as the provenance of the key device. For instance, if a key is used improperly a certain number of times, or in combination with certain other lock devices or key devices, it may determine independent of the volition of its user that it must cease functioning. Of course, a large variety of permutations of all these four basic key management methods are possible.

There are at least five basic modes for controlling access privileges through the management of the dialogue between the key device and the lock device. First, trivially, each lock device could have a fixed password as is taught in the prior art. Only key devices presenting correct the password could operate each lock device.

Second, the dialogue between the lock device and the key device could further involve communication with a network. This can take two forms. In the first form, the key device which preferably is arranged to communicate with a network may, while in communication with a lock device, make inquiries of other network connected devices in order to obtain information necessary to satisfy the lock device of the authority of the key device to actuate the lock device.

In the second form involving network communication, the key device could provide the lock device with a channel by which the lock device may communicate with the network. This is distinguished from the first form in that the key device does not receive or act upon the information transmitted through it between the lock device and the network other than to relay it between the other two devices. In practice this would be analogous to a human guard confronting an unfamiliar person at the entry gate to a facility. The guard may be able to verify that the person has presented proper credentials, but still not know whether the person is to be properly allowed access. To find out, the guard places a call to a central authority and discusses the situation. Together, the guard and the central authority arrive at a consensus decision on whether to allow access. To extend the metaphor, imagine that the guard has no telephone of his own, but must borrow the cell phone of the unfamiliar person to place the call to the central authority. The guard may have to go through elaborate procedures to insure that he has obtained a secure connection to the legitimate central authority, but such encryption and/or authentication methods are known. Similarly, the lock device of the invention can communicate to the network through a channel provided by key device. The lock device can use that communication to determine whether the key device is then to granted access.

In the third basic method the lock device could permute its required password periodically. Just as with the key device, there is no reason for the password of the lock device to be fixed. Nor would it be necessary for it to be changed manually. When the lock password changes, to operate the lock device, the key device must acquire a new password. The algorithm by which the lock device selects its new password is preferably obscure to the key device, forcing the key device to be in contact with the network to obtain, if permitted, the new password.

Fourth, the lock device may contain a fixed matrix of access privilege conditions. For example, the lock device may require that a certain key device provide certain access codes on certain dates. Assume that the matrix is not stored in the key device. After some time, only key devices which are authorized to communicate with the network would be able to receive the needed code to access the lock device. Such a matrix could embody a set of rules for the proper access privileges of key devices to actuate the lock device base on the provenance of either the lock device or the key device, e.g. who last actuated the lock, where the key was last used, etc.

Fifth, the lock device could contain complex algorithms for the generation of new access codes in response to any number of conditions. Such a state machine would be analogous to other cryptographic systems. Here disablement of the privileges of the key device could be achieved by simply withholding from the key device some element of the algorithm or code sequence necessary to respond to a cipher generated request.

Clearly, the above basic methods for the management of key devices, and of the dialogue between key devices and lock devices, could be used in a large variety of combinations. This is a striking departure from the simple mechanical lock and key systems currently in use in retail today. It is a similarly striking departure from conventional RFID, EAC, and intelligent lock systems today wherein the analogous key devices possess a single code for entry. In the present invention, the interactions between the lock device and key device, between the network and the key device, and between the lock device and the network through the key device, provide enormous new opportunities for economical systems deployment, for timely and flexible management of access privileges, and for timely and reliable collection of use information. All these features can be completely automated.

It is significant that neither lock devices nor key devices need be in any way associated with a single facility. Locks devices may be affixed to secure parcels, such as shipping totes and luggage, which are exchanged between facilities and indeed between organizations. Keys devices may travel with individuals dealing with plural organizations. An example of this would be a delivery person for a brand of consumer product goods who travels from store to store to replenish merchandise. It is not new that lock devices may be shipped. What is new are the features of those lock devices which now allow controlling authorities to securely manage the virtual distribution of the access privileges to key devices previously distributed.

Contrasted with the prior art, the invention provides, among other advantages, easy automatic management of key privileges, and easy physical exchange of lock devices among facilities. Significantly, no network or power infrastructure or connection is necessary for the lock devices. Further, no labor is required, and hence no willful cooperation of users is required, to obtain information about the use or attempted use of key devices.

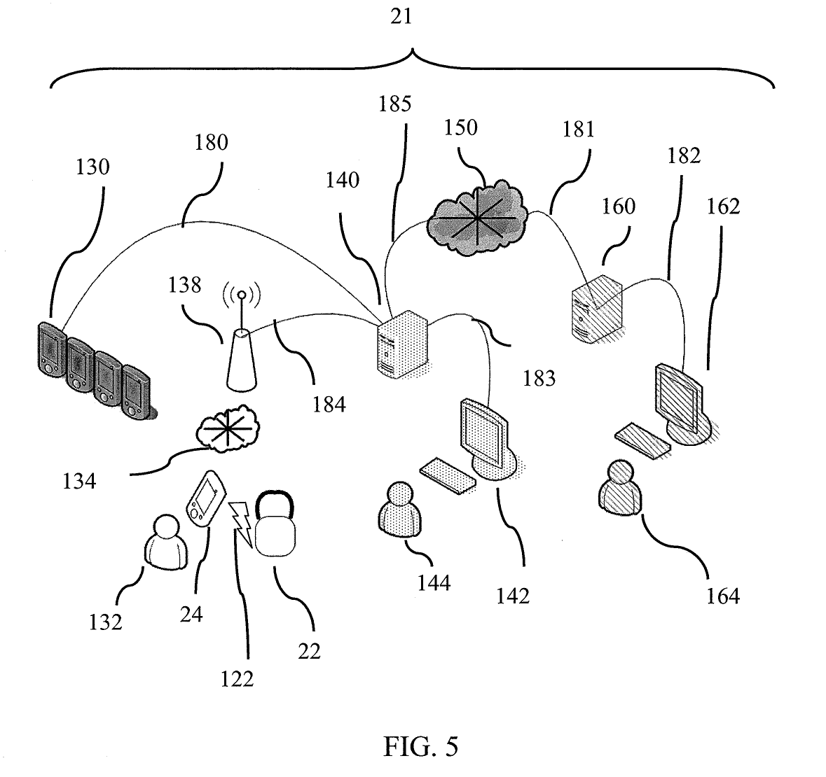

Referring now to the various figures of the drawing wherein like reference characters refer to like parts, there is shown in FIG. 5 a universal lock system 21 constructed in accordance with one exemplary embodiment of this invention. By “universal” it is meant a system which may include a variety of formats of lock devices all compatible with an associated variety of key devices. In this example, the lock device is depicted as a low cost, robust, strong, portable lock device 22. The key device 24 is a remote, electronically-operative, hand-held member for actuating the lock device 22. In most cases by “actuating” it is meant either locking or unlocking the lock device 22.

A user 132 uses the key device 24 to actuate the lock device 22 via a wireless communication channel 122. The key device 24 communicates separately to a local database 140 over a wireless network 134 through a wireless hub 138 and the hub's network connection 184. The privileges of the key user 132 maybe set by a manager 144 through a terminal 142 via a network connection 183 to the database 140. Key users may acquire their key devices at an optional registration station 130 which is optionally connected 180 to the database 140. Events reported by the key device 24 and other information entered by the manager 144 may be shared with a remote database 160 via a wide area network 150, such as the Internet, and network connections 185 and 181. This data is thereby conveniently available for analysis by an investigator 164 using a terminal 162 over network connection 182. The investigator 164 may disable or alter any or all access privileges, such as to a specific lock device 22, a specific key device 24, a specific user 132, or even a manager 144 or a terminal 142.

The lock device 22 and key device 24, can, of course, take many forms, as can many other elements of the system, as well as the configuration of the system. To understand these options, below follows in turn discussions of: the key device, how the key device may be managed, the lock device, basic interaction of the lock device and the key device, more advanced options for this interaction, and finally other options for the configuration of the lock device, key device, and the system. Thereafter are descriptions of derivative applications of these configurations.

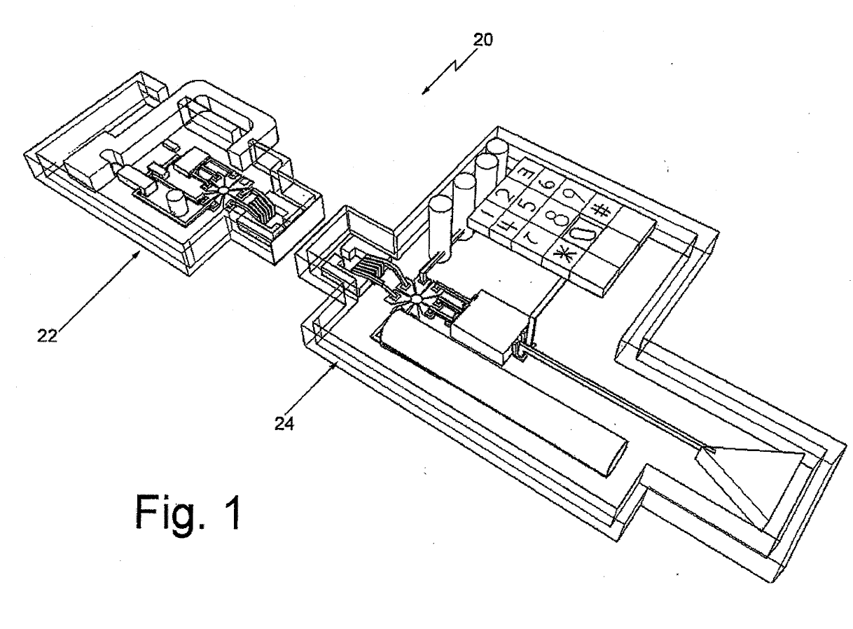

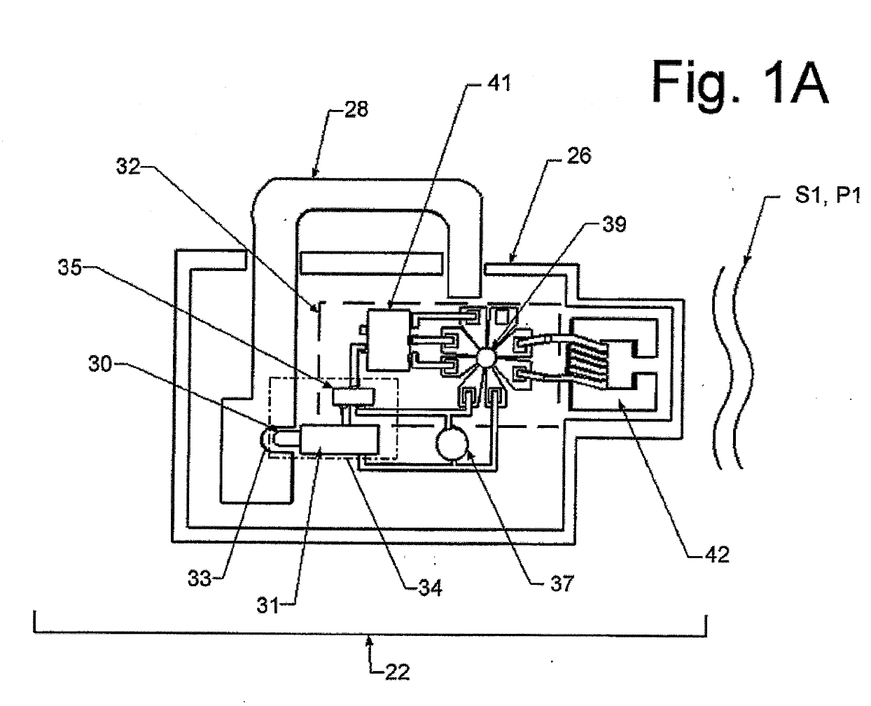

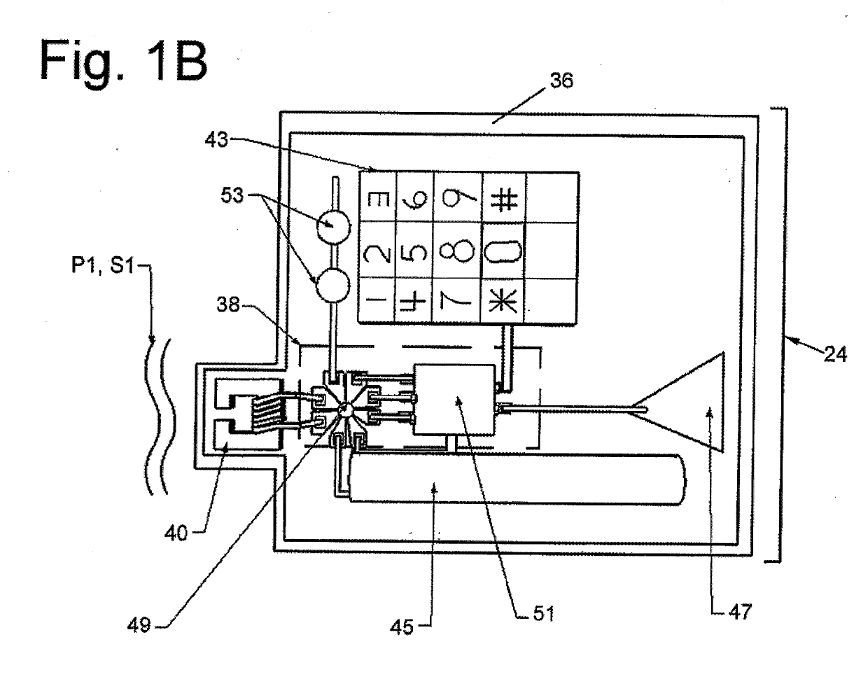

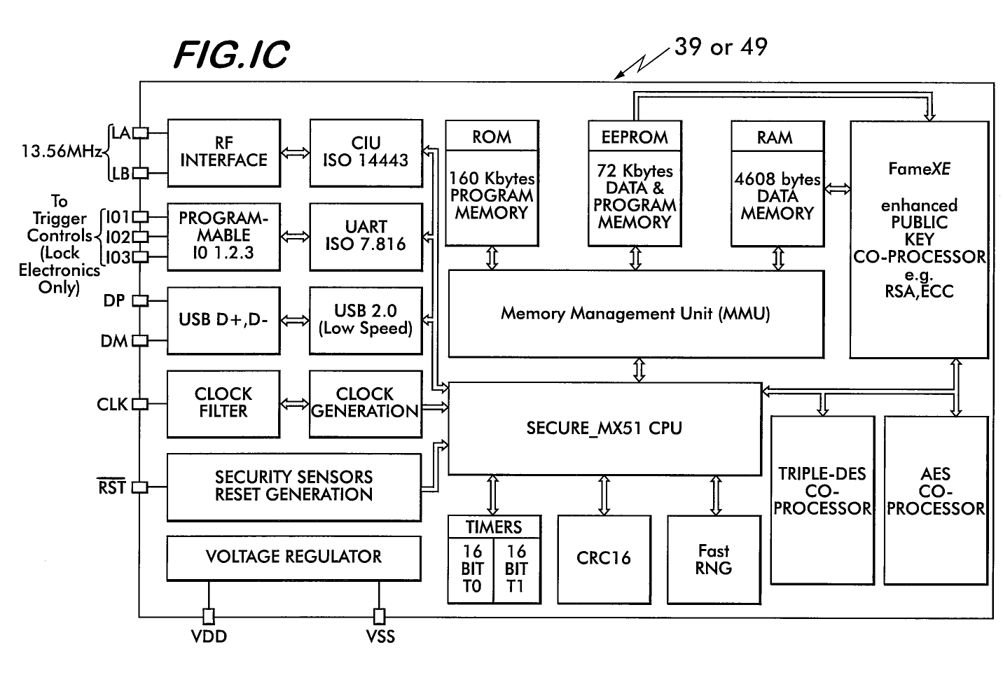

Referring to FIG. 1, in its simplest form the locking system 20 of the subject invention consists of a lock device 22 and a key device 24. These electronic devices may incorporate a variety of optional aspects. At all times they incorporate the means to communicate with each other, normally bi-directionally. The key device may work in concert with a variety of other devices within a facility. The lock device, however, normally works in concert only with the key device and the object which it is controlling or securing.

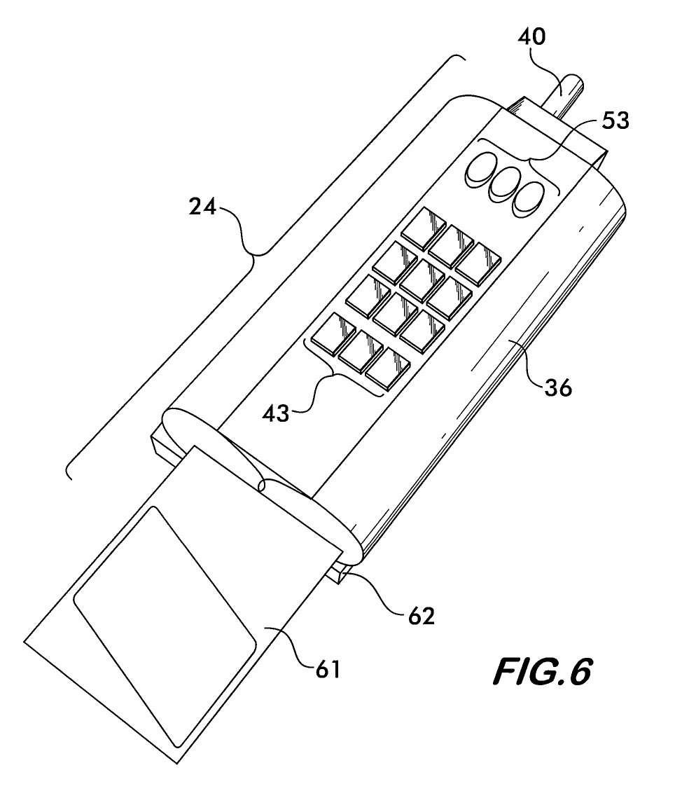

The key device 24 can take a variety of forms. In the interests of drawing simplicity, an exemplary key device 24 is shown in FIG. 1B. The exemplary key device 24 comprises a housing 36 which contains the on-board electronics 38, a first antenna 40, a keypad/display 43, a power source 45, a second antenna 47, and a plurality of indicators 53 (four of which are shown in FIG. 1, two of which are shown in FIG. 1B, and three of which are shown in FIG. 6.)

The power source 45 may comprise a battery (e.g., large NiCad battery), which may also be rechargeable, for powering the key's on-board electronics and indicators. The battery 45 also provides the electrical power P1 that is transmitted to power the lock device 22. It should be pointed out that the power P1 may be wirelessly transmitted to the lock device 22. It need not be conducted electrical power. Thus, for example, the power P1 could be in the form of electromagnetic radiation such as light, a magnetic field, or microwaves, etc. It may also be ultrasonic power. In such alternative arrangements, the key device 24 includes some means for producing the alternative wireless power signal and the lock includes some means to convert the alternative wireless power signal into an electrical signal for use by the lock device's electrical circuitry.

In the example of FIG. 1B, the antenna element 40 transmits both a power signal P1 and a data signal S1 to the lock device 22. The content of the communication with the lock device is managed by an encryption core 49. Normally the key device also contains a CPU (central processing unit) 51. The CPU manages dialogue with the user through optional input devices 43 and output devices 53. The CPU typically also manages the optional network communication channel via an antenna 47. Through antenna 47, the key device preferably transmits information regarding its usage to a central database its equivalent (e.g., item 140 in FIG. 5.)

In a further embodiment a portion of the data on at least one communication channel is encrypted. Preferably all communications among lock devices, key devices, local databases, and remote databases would be secured by encryption.

Although less preferred the communication between the electronic key and the computer system can be other than wirelessly, e.g., it can be by hardwired network connection, an infrared link, or by physical connection to a port on the computer network, etc.

The keypad/display 43 comprises any conventional input/output (I/O) device that a user can read and manipulate in order to respond to the interrogation/communication that is initiated between the electronic key device 24 and the lock device 22. A plurality of indicators 53 (e.g., light emitting diodes, or LEDs) may be provided to prompt the key user in responding to inquiries from the lock device 22 and/or may supplement the keypad/display 43 responses by providing a status as to the condition of the lock device 22 (e.g., lock is awaiting a response from the key device 24, low power on the key device 24, lock is currently unlocked, lock is currently locked, etc.). Together, the encryption core 39 and the CPU 51 cooperate to generate encoded data signals, based in part on user inputs from the keypad/display 43, in order to provide the wireless data signal S1 in response to inquiries from the lock device 22. The core 39 and CPU 51 also provide decryption functions for signals received from the lock's on-board electronics 32. The first antenna 40 is electrically coupled to the encryption core 49. It should be noted that an exemplary core module 49 for use by the key electronics 38 is similar, although perhaps not identical, to the one depicted in FIG. 1C. Thus, the on-board circuitry 38 of the key device serves as a transceiver to send control and data signals S1 to the lock device 22 and to receive electrical signals from the lock device 22. To that end, the antenna 40 is provided as part of the transceiver. It should be pointed out at this juncture that the signals S1 that are sent by the transceiver's antenna 40 to the lock device 22 can also be used to power the on-board circuitry 32 of the lock device 22 in addition to providing that circuitry 32 with the data and control information, so in that case an independent power signal P1 would not be needed.

FIG. 6 depicts the exterior of a key device 24 of the subject invention as a user might view it. Here the antenna 40 for communication with the lock device 22 is shown protruding from the housing 36. The user interface is shown as consisting of a keypad 43 and a set of LEDs 53. Unlike FIG. 1B, FIG. 6 shows an optional card reader 62 by which a user identification card 61 may be read or written to. Such a card may be useful for identification purposes to activate the key device 24 or for the transfer of data to or from the key device 24.

In addition, and in accordance with a preferred aspect of this invention, the key device is also arranged to wirelessly communicate with any computer system of a business, such as a cash register, the inventory management and control system, etc. Referring to FIG. 5, the key device 24 is preferably connected by some path to a central database 140 controlling the use of key devices within the facility. However, this is not strictly necessary. The key device could be isolated and communicate only with lock devices. Alternatively, it could communicate with only one additional specialty device, such as, for example, the cash register.

The invention provides a variety of mechanisms whereby a simple, intuitive, and optionally automatic key device management regime may be achieved. The management of key devices includes the ways in which keys are enabled and disabled, and the ways that that the uses of keys are monitored.

In a further embodiment the key device is enabled only upon the presentation of acceptable credentials to either the key device or to a local or remote database. Thereby the ability of the key device to communicate with lock devices can be disabled permanently or temporarily pending submission of acceptable credentials. This could be accomplished by disabling the communication channel by which the key device communicates with lock devices. Alternatively, disablement may be achieved by withholding the release of certain data items which are essential for obtaining responses from certain lock devices.

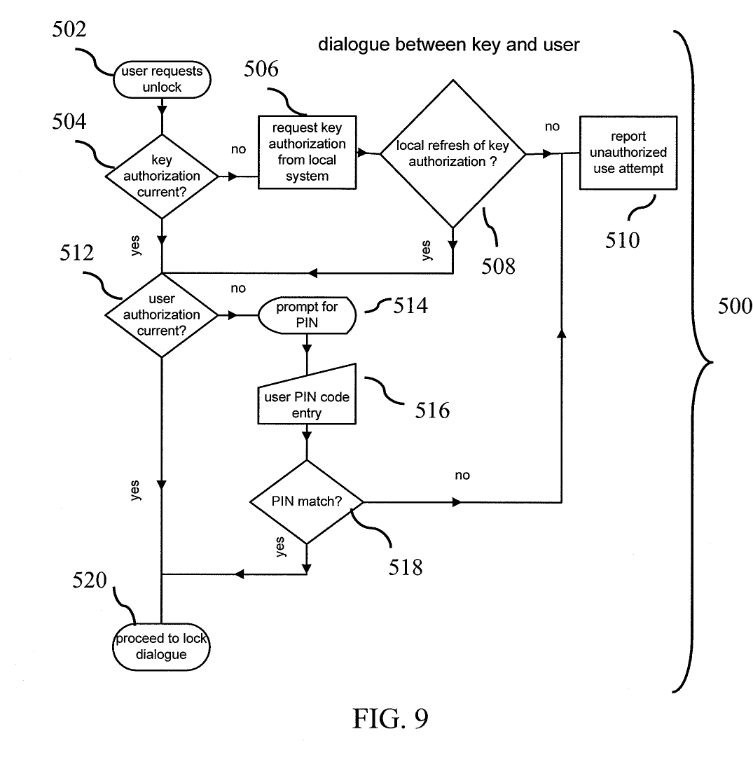

FIG. 9 is a schematic representation of an exemplary embodiment of the subject invention in the form of a process for dynamically controlling user operation of key devices. The process 500 begins when the user makes an action indicating a request for access 502. The key device makes a determination 504 whether or not it itself is authorized to proceed. Such authorizations may have time limits. If not, the key initiates a connection 506 to the local database which in turn decides whether to authorize the key 508. The local database normally holds a record of this decision either way. In the case that access is denied, it may make an immediate report of the event to a remote database 510. Once the key is authorized, the key device decides separately whether the user of the key is currently authorized 512. A key device may be required to re-authorize by contacting the local database every day, every hour, or even every minute. A user may be required to re-authorize, for example, if ten minutes have elapsed since the last use, or every ten uses, or whenever the key loses connection with the local database. If the user authorization is not current, the key device may prompt the user to enter pass code 514. The user then enters the code 516, which is verified by the key device 518. Failing codes may be reported 510 immediately to the local database, the remote database, or both. Once the user is authorized, further processing may proceed to engage the lock device in a dialogue 520.

In a further embodiment the key device is automatically disabled periodically for added security. Such disablement can take place simply due to the passage of time. This disablement could be effected by either the receipt of a command from the network, or by an internal timing process within the key device.

Similarly disablement of the key device may be triggered by other factors. In a further embodiment the first database is arranged to disable the key upon a condition selected from the group consisting of: a command from a local or remote database; a command from a user of a local or remote database; a command from the lock; and an automatic limit threshold. For security purposes, it is important to identify and neutralize malefactors attempting to abuse access privileges. This could be achieved by disabling the key device. The disablement could be triggered by automatic or manual methods. Non-limiting examples of manual methods include database user commands. Non-limiting examples of automatic methods include a high security lock issuing a command to disable a low authority key device that is improperly presented, and alternative a database system process which issues a disablement command in response to the user of the key achieving an abnormal or proscribed level or type of use.

As noted earlier, whenever a key device and lock device interact, it is advantageous that the details (e.g., time, date, user, result, etc.) of this interaction be recorded. Referring to FIG. 5, this may be achieved by having the key device 24 automatically transmit such data to a remotely-located receiver 138 which communicates in turn with a database 140. This creates a trail of forensic quality data. As such this data can be used defensibly as a basis for making human resources decisions such as, but not limited to, discipline, dismissal, payment of bonuses, or promotion, as may be appropriate. Referring to FIG. 1B, the network communication channel of the key device 24 may be implemented as IEEE 802.11 protocol variants or similar interface. This may require that a special applications and communications processor 51 and antenna 47 be included in the key device 24. These are separate from, and in addition to, the core processor 49 which communicate with the lock device 22 via the lock interface antenna 40.

This logging of data can occur in real time. Herein “real time” is understood to mean sufficiently concurrent with an event to allow dispatch of potentially effective countermeasures to minimize potential economic losses due to the event. For example, sounding an alarm or securing a perimeter when a lock has been forced would be considered a real-time response to the thief attempting to leave the scene with the stolen goods.

Ideally, whether or not in real-time, this transmission should occur independently of the volition of the user of the key device.

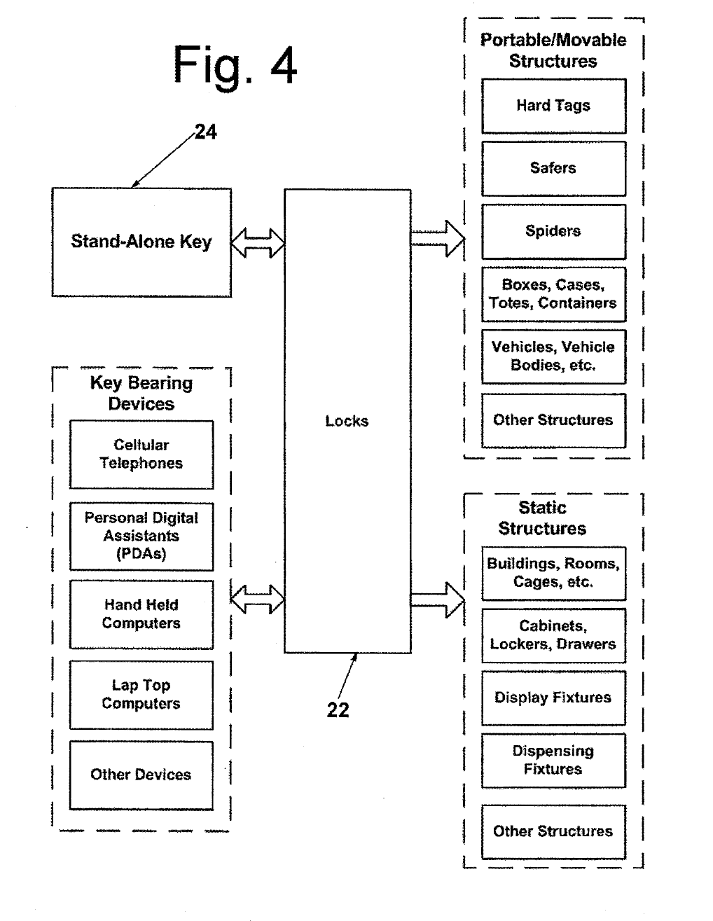

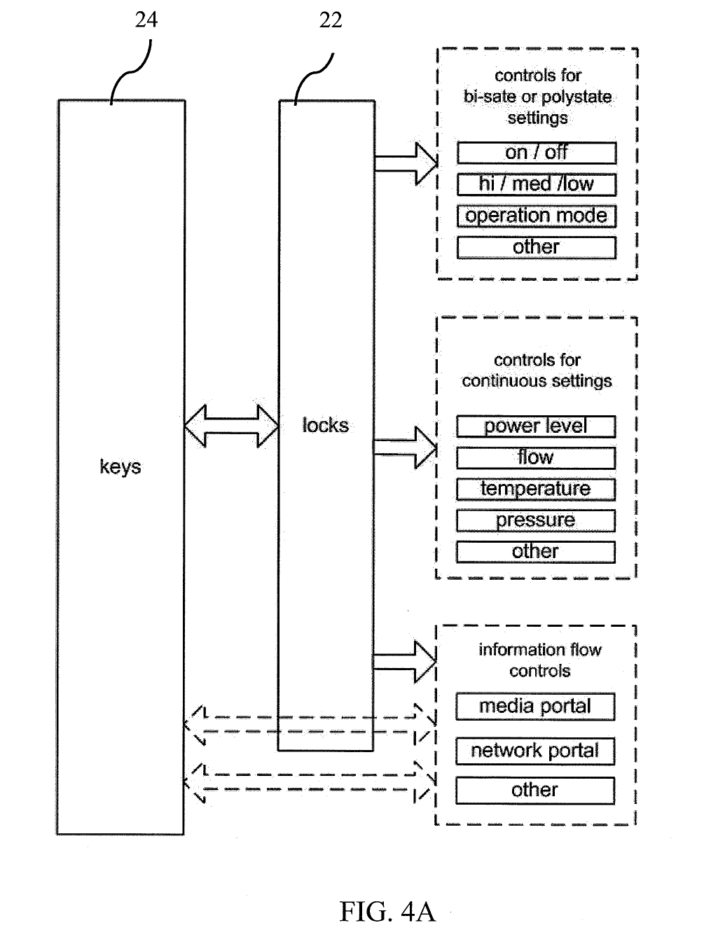

Now that the basic operation of the key device is understood, it is appropriate to consider the internal operation of the lock device. In the interest of simplicity, FIG. 1A depicts an exemplary lock device 22 performing the familiar function of an ordinary padlock. The circuitry 32 is preferably programmable to enable the lock device 22 to be used for numerous applications such as those shown in FIG. 4 and FIG. 4A. The lock device 22 basically consists of three sections: a key interface, a mechanical interlock, and an electromechanical interface. Referring to FIG. 1A, the key interface of the lock device 22 consists of a wireless interface antenna 42 and a wireless communication processor 39. The mechanical interlock consists of a housing 26, a bar 28 with a notch 33, and a latch 30. The electromechanical interface consists of an energy storage device 37, a trigger mechanism 34 possibly comprising a trigger control 35 and a trigger 31, and, if required, a core interface 41.

The key interface of the exemplary lock device 22 operates as follows. Preferably the key device 24 communicates data to the lock device 22 via a wireless data signal S1. Other means of power and communication transmission, such as contact and optical means, are possible. However, the data signal S1 preferably comprises radio frequency (RF) signals in the range of approximately 100 kHz to 6 GHz. This could be a variant of an established 13.56 MHz specification, such as ISO 14443. Protocols operating between, for instance, 100 kHz and 100 MHz are better suited to this than protocols operating at higher bands such as 950 MHz or 2.54 GHz. Lower frequency magnetic mode coupling antennae can reduce the susceptibility of the transmissions between key devices and lock devices to being intercepted. The data signal S1 is received by a pickup antenna 42, which here is depicted as a winding about a core, but could take many forms. The signal is then interpreted by the wireless communication processor 39. The data interface may be bidirectional, in which case the communication processor 39 also synthesizes responses to data signals received from the key device.

Preferably the key device 24 also provides a power signal P1 wirelessly. The lock device 22 is preferably a passive component, i.e., having no on-board power, but instead relies on power transmitted wirelessly to it from the electronic key device 24 or some other wireless transmitter. The wireless data signal S1 and wireless power signal P1 could either be separate signals or different aspects of a single signal. For instance, P1 could be the 13.56 MHz carrier of an ISO 14443 signal, and S1 be the data content of the same waveform. Power to operate the circuitry 32 and electromechanical devices could be rectified by the communication processor 39 and store in energy storage device 37, which could take the form of a capacitor.

While a totally passive lock is preferred, it is never the less contemplated that the lock device 22 could include a very long-lived power battery for powering all or a portion of the circuitry of the lock over a very long period of time (e.g., years), without necessitating battery replacement. In such a case, the power storage device 37 would comprise a battery.

Rules and data for determining under what circumstances the lock device will be operated by a key device can be stored in wireless communication processor 39 (FIG. 1A). Such rules and data can be preprogrammed into the circuitry or changed “on-the-fly” (wirelessly transmitted to the circuitry). Cryptographic and other electronic security features are preferably included in the lock, via its on-board circuitry 32. Further still, the on-board circuitry 32 is preferably able to provide wireless signals back to the electronic key device 24 indicating its operating and usage parameters, e.g., when the lock was opened, by whom, and under what conditions; whether the lock is currently in a secure state, clarifications necessary to effect operation; etc.

This feature enables the lock device to be an integral part of a data collection system for keeping track of inventory, personnel, suppliers, etc. or as part of a mobile commerce system. It should be further noted that this time-date stamping and identity-of-user function of the electronic key device 24 provides a crucial feature of the present invention: eliminating undocumented use of the lock device 22. In other words, a person trusted or authorized to use the electronic key device 24 to open the lock device 22, may still choose to, or unknowingly, be part of an unauthorized act. The fact that the every key device-lock device interaction is recorded provides an important deterrent since the recordation of the key device-lock device interaction event automatically occurs.

Thus, besides pre-storing passwords into the lock device on-board electronics 32, specific personal details may also be stored into the lock device on-board electronics 32 that only a particular user would know. As a result, during the authentication communication occurring between the lock device 22 and the key device 24, the inquiry to the key device 24 user may be a personal question such as the maiden name of his/her mother.

It should be pointed out that the transmission of the data to the remotely-located receiver 138 and database 140 need not be accomplished via the second antenna of the key device 47. Thus, it is contemplated that the data may be transmitted by the antenna 40 of the key device or even the antenna 42 of the lock device. Moreover, it is contemplated that the key device 24 may or the lock be brought to some location where its data can be downloaded via a hardwired connection for use by the remotely-located database 140.

The mechanical interlock of the exemplary lock device 22 of FIG. 1A is analogous to that of an ordinary padlock. It should be pointed out at this juncture that locks can be constructed in accordance with this invention that are not of the padlock type. This invention contemplates any type of lock which is arranged to be opened or unlocked either manually or, alternatively, automatically when an appropriate signal is received from the key. Further, this invention contemplates other devices which are manipulated by means of keys, such as electrical switches, electrical controls, and valve controls.

Referring to FIG. 1A, like a conventional padlock, the exemplary lock device 22 includes a case or housing 26, a movable bar 28, and a latch 30. The latch 30 can be of any suitable construction. In the exemplary embodiment shown, the movable bar 28 is prevented from displacement away from the housing 26 due to the presence of the latch 30 in a cavity 33 in the bar 28. By way of example only, the trigger mechanism 34 may comprise a spring loaded device, which stores potential energy when the bar is closed, i.e., the mechanical force applied to close the bar 28 so that it is locked is transferred to the trigger 31 where it is stored for later use (release) to unlock the bar 28 when triggered (as will be described later). Alternatively, the trigger mechanism 34 may include electronic control of the latch 30 and, as such, may also comprise a trigger control 35 portion for controlling the trigger 31 to extend or withdraw the latch 30.

To understand the electromechanical interface of the exemplary lock device 22, it is beneficial to first consider the analogous operation of a conventional padlock. A conventional padlock basically comprises a housing, a movable bar (e.g., a U-shaped member) connected to the housing and which is arranged to be moved with respect to the housing between an open and closed position and vice versa, a tumbler mechanism which is located in the housing and constitutes the interpreter for the lock's key so that the lock “knows” which key to allow and which to deny, a trigger which responds to the tumbler mechanism sensing the appropriate key being in place and a latch coupled to the trigger to hold the bar securely in place (closed) until the latch is actuated by the trigger in response to the appropriate key cooperating with the tumbler mechanism. The housing constitutes the case for the lock that keeps the latch, trigger, and tumblers free from tampering

The communication processor 39 comprises a function analogous to the tumblers of the padlock. It is arranged to determine whether the key device 24 with which it communicates should be allowed or denied access. Access in this example is the actuation of the trigger 31 to release the latch 30 and allow free motion of the bar 28. If the core communication processor 39 decides that the key should be allowed access, the electromechanical interface converts that electronic decision into physical action.

The communication processor 39 can be realized as a “smart card” core module. FIG. 1C depicts an exemplary “smart card” core module 39 and, by way of example only, this may be implemented using a Philips Semiconductor P5CT072 Secure Triple Interface PKI Smart Card Controller, or any other suitable electronic circuit. Referring again to FIG. 1A, the core module 39 in the lock electronics 32 comprises memory containing a plurality of passwords and other authenticating details which are pre-stored and that are used by the core module 39 to analyze the data received from RF signal from the electronic key device 24 in order to determine whether to activate the trigger control 35 or not. As mentioned earlier, there may be a series of bi-directional wireless communications between the lock device 22 and the electronic key device 24 in order to establish the authenticity of the user holding the key 22; thus, the core module 39 generates encoded authenticity questions for the holder of the key 22 which, in turn, responds with encoded responses. Only if the lock electronics 32 are satisfied with the answer, will the core interface 41 activate the trigger control 35 to release the latch 30 and thereby the moveable bar 28. FIG. 1A depicts a core interface 41 which, if necessary, may serve as an internal input/output encoder/decoder to connect the core processor 39 with other electronics, sensors, or actuators within the lock device assembly.

Preferably the exemplary lock device 22 includes a trigger mechanism 34 that is arranged to be actuated by very low power. The trigger mechanism 34 comprises a trigger control 35, a trigger 31 and the latch 30. The trigger 31 is arranged to be responsive to an actuation or trigger signal (indicating that the lock should be opened) from the trigger control 35 to activate the trigger 31 to retract the latch 30 to enable the bar 28 of the lock device 22 to be opened. It should be understood that the trigger control 35 emits the trigger signal to the trigger 31 only when the on-board electronics 32 is satisfied that an authorized person is using the key device 24 based on the communication occurring between the on-board lock electronics 32 and the on-board key electronics 38.

As mentioned above the latch 30 of the lock device 22 may comprise a spring loaded device. However, it can be of other constructions, each of which being arranged to store considerable mechanical energy in it and which is available for release when triggered by the trigger mechanism 34. This arrangement allows the lock to automatically open itself upon being triggered. In this regard, in the exemplary embodiment shown, the latch 30 is coupled to the movable bar 28 so that when that bar is manually closed by a user, the mechanical force applied to close the bar applies energy to load the spring of the latch. That spring in turn stores the energy as potential energy available for release when the latch is triggered (actuated) by the trigger mechanism 34. It should be pointed out at this juncture that it is contemplated that for some applications the latch 30 need not store sufficient energy to open the bar 28 by itself, but merely store enough energy to release the latch 30 so that the bar can be manually opened, e.g., the bar 28 pulled away from the housing 26 by a user. Alternatively, the trigger mechanism 34 may include inductive actuation.

As mentioned above, the trigger mechanism 34 is preferably arranged to be capable of operation with very low power. Moreover, and quite significantly, the trigger mechanism 34 should only operate in response to an appropriate actuation signal. Thus, it should be immune to spurious activation or triggering caused by external mechanical forces, such as shock, vibration, temperature change, etc., and/or external electromagnetic and other conditions, e.g., temperature changes, applied magnetic fields, etc.

Various types of trigger mechanisms 34 can be utilized in this invention providing that they are capable of operating in response to an electrical signal, e.g., they may constitute electrical to mechanical transducers. In this regard it is contemplated that the triggers may make use of artificial muscles, polymeric gel actuators and electroactive polymer transducers. Triggers based on piezo electric crystals, Hall Effect devices, and eddy current technologies may also be used. Examples of artificial muscle and polymeric actuators are found in U.S. Pat. Nos. 5,250,167 (Adolf et al.); 5,389,222 (Shahinpoor); 6,475,639 (Shahinpoor et al.); and 6,876,135 (Pelrine et al) and all of whose entire disclosures are incorporated by reference herein.

Now that the way the lock device opens has been described, it is appropriate to turn to ways in which the operation of the lock devices is managed by the operators of the locking system. In prior art EAC systems, locks are connected to the controlling network and thereby receive information about which key holders to admit and which to deny. While the lock devices of the subject invention may be installed in conjunction with locks of kind, the lock devices of the subject invention are preferably not connected directly to the controlling network. Therefore other means are necessary to insure that changes in the authority of key users are reflected promptly in decisions made by the lock devices.

As noted above, a variety of methods are available to manage the operation of key devices. These by themselves may be sufficient in many cases to prevent unauthorized access to locked items. The prior art smart detachment systems work in this way, in that any authorized detacher can open any lock. In other words, those locks have no means to refuse to open for any energized detacher. Greater security, however, requires that the lock devices incorporate methods for judging and refusing the requests of key devices to open. There are several modes of operation contemplated by the subject invention by which this can be achieved.

Preferably, for security reasons, a lock device should be unalterable after either its manufacture or its installation. While it is understood that access privileges could be stored in a lock device as they are in other access control scenarios, this would require maintenance of the lock data over time in the case that users must be added or removed from the list of those with authorization access. Therefore, it is preferred that a lock device be arranged to either: communicate with a network device through a channel provided by the key device to determine whether to operate; shift the code required of a key device to operate the lock device; contain a variety of criteria credentials that may be used at different times from different key devices to operate the lock device; or generate random or cipher interrogatories which a key device must answer satisfactorily to operate the lock device. Further details of each of these modes are provided below.

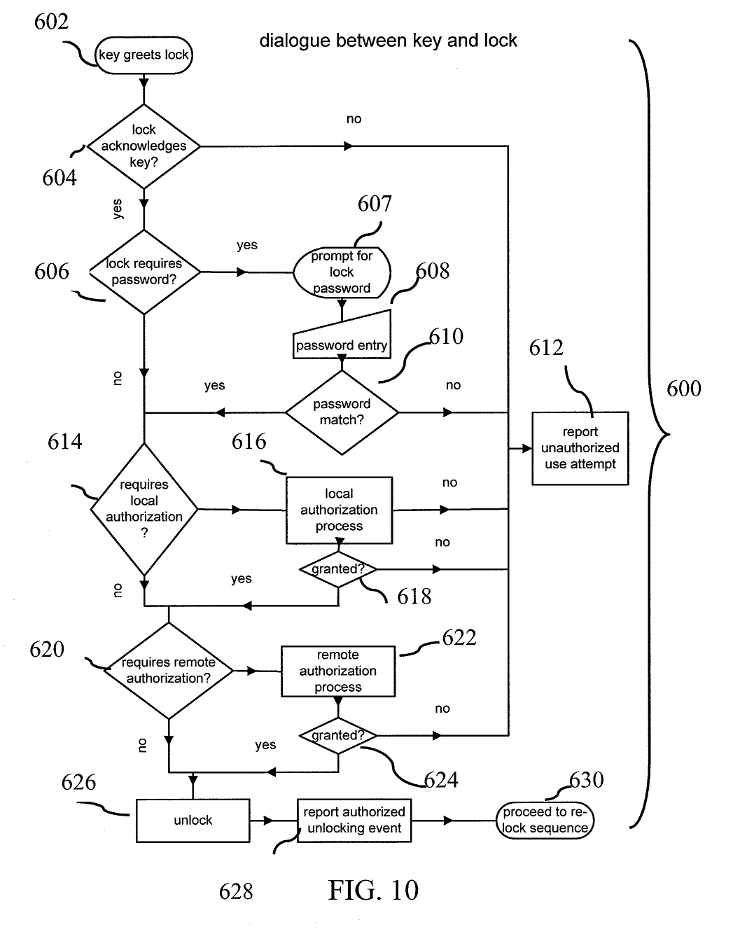

The first mode is the simplest method to prevent an unauthorized key device from gaining access to a lock device. All that is necessary is that the lock device to require a simple password or pass code from the key device. When a key device incorporates a user interface, even this simple process can comprise several steps. FIG. 10 is a schematic representation of an exemplary embodiment of the subject invention in the form of a process 600 for dynamically controlling lock device and key device interactions. The key device initiates dialogue 602 by connecting to the lock device and proffering access credentials. The lock device decides whether to respond 604. On refusal, an improper access attempt may be reported 612. This reporting may occur immediately. A history of such events may be maintained additionally in either or both the lock device 22 and the key device 24. On acceptance the key device may require 606 the user to re-enter the user's pass code or a pass code specific to that lock device 607, in which case the key device will prompt the user 608 and record the pass code provided 610, and either the key device or lock device will determine whether the proper code has been entered. Again, all failed attempts may be reported as such 612. The second mode involves dialogue with other devices on the control network through the network communication channel of the key device. In this mode, the lock device requires that the key provide proof that it is currently authorized by the network to access the lock. This may either mean local network devices, such as a cash register or database system, or remote network devices, such as databases at remote facilities connected via telephony or the Internet.

The necessary secure communication may be achieved by means of either encryption or authentications which are known in the art. In any case, the key device must relay the communication from the lock device to the networks, since the lock device preferably has no network connection of its own independent of the key device.

Referring again to FIG. 10, an exemplary embodiment of this process is depicted beginning at step 614. The lock device determines whether the credential of the key device or the user of the key device is to be confirmed through dialogue with the local database. In the case that local authorization is required, the key device enables and optionally participates in a dialogue between the lock device and the local database 616. The lock device decides whether this process terminates favorably for the user request 618. Similarly, the lock device may require confirmation of access credentials through dialogue with a remote database 620. If yes, this initiates a process involving the lock device, the key, the remote database, and optionally the local database 622. The lock device weighs the outcome of this process 624 and may then unlock 626, report the unlocking 628, and proceed to an optional relocking process 630.

Consider the example of a delivery person looking to restock a secure razor blade dispensing fixture. Using prior art systems, the delivery person could carry a different key for each fixture on his route. Using the present invention, the delivery person could carry a single key device which is authorized by a remote database of the store chain headquarters. Upon arrival in the store, if the delivery person's key device is not listed and authorized in memory of the lock device, the lock device can request that the key device allow the lock device to query the local database regarding the authority of the delivery person. If the local database is unaware of the credential status of the delivery person, it in turn could initiate a connection to the remote database to verify that the delivery person is authorized to gain access to certain fixtures in that store for the purpose of replenishing inventory. A random key can be deployed to a random store where a random fixture has also been deployed. Together the lock device, the key device, and the network devices could construct the necessary records to make the appropriate access decision, and require no human intervention to do so.

In a third mode, a lock device may control access granted to key devices by shifting the codes required for entry. Thus, instead of keeping the pass code fixed, the lock device shifts the code based on a trigger condition, such as, but not limited to, the passage of time, the number of times that the key device and the lock device have interacted, etc. Unlike the second mode, the third mode does not require that the lock device be in communication with the network via the key device. The shifting of the code is done by the lock device independent of actions by the network. The key device must be able to produce the new codes required by the lock device. The key device may be arranged with the necessary information or computational tools to do this. Alternatively, the key device may receive the new codes or elements necessary to generate the new codes from the network.

In a fourth mode, a lock device may control access granted to a number of key devices by way of a matrix of credentials and/or associated codes. Non-limiting examples of such credentials include the serial number of the key, the identity of the current key user, the identity of the assigned key user (if not the same as the current key user), the assigned access authority level of the key, the institutional affiliation of the key, and the provenance of the key. Non-limiting examples of such institutional affiliations of the key device include the institution by which the user of the key is employed, the institution for which the user of the key is assigned to work, the institution for which the key is assigned, the geographic region in which the key is assigned, a specific facility for which the key is assigned, a specific department for which the key is assigned, and a specific lock for which the key is assigned.

Having each key device carry a variety of credentials assists in the management of complex locking scenarios. Consider the example of a retail store. There are locks at the entrances and exists, on cash registers, cases, closets, cabinets, and equipment. Typically access to these is limited to local store staff, supervisors, or managers. But there are also dispensing product fixtures to which third party suppliers or supplier service firms will need access. Rather than managing access to individual lock serial numbers in a central database, using a variety of credentials it is much easier to provide access configured by lock device and key device types and affiliations.

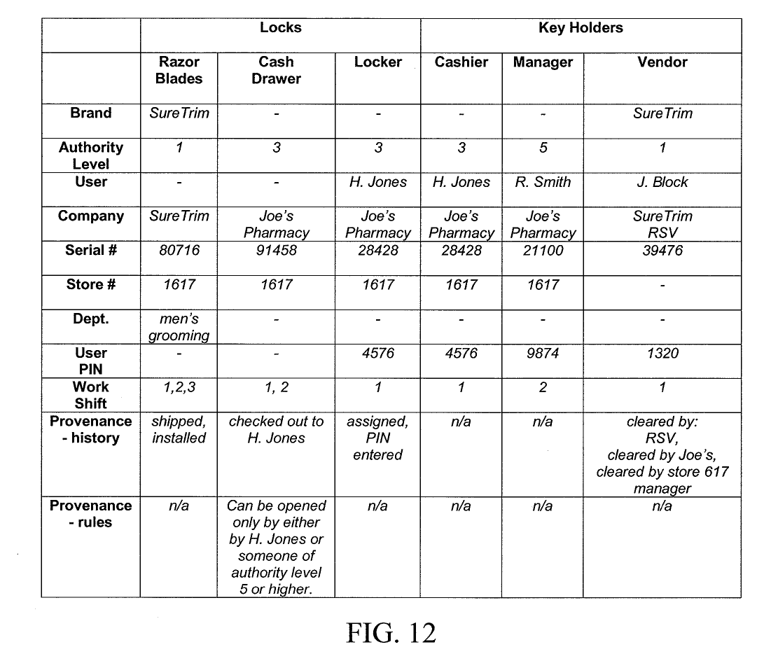

FIG. 12 is a table or matrix representing an exemplary embodiment of the subject invention depicting access credentials of lock devices and of key devices as may occur in a retail facility. In this example, lock devices and key devices are provided with identities made up of brand, authority level, company, serial number, store number, department, PIN (personal identification number), work shift, provenance history, and provenance rules. Such data, and associated codes or code algorithms, may be stored in key devices, lock devices, and local or remote databases.

In this example, the lock device securing the cash drawer will permit access only to a key device which can demonstrate and/or authenticate the following: the security level of the key user is 3 or higher; the key device is assigned to store 1617; the key is assigned to an employee of Joe's Pharmacy; and the drawer is being accessed during shift 1 or 2 by an employee assigned to that shift. The manager and the cashier would be able to open the cash drawer lock device using their key devices. The retail service vendor (RSV) for SureTrim would not be able to open the cash drawer. The SureTrim vendor can only access the lock device of the razor blades merchandising fixture.

Such a matrix is greatly advantageous for the ease of deployment of lock devices and key devices, and for the management of access privileges. Rather than maintaining a central record of all serial numbers across all institutions, access information can then be distributed. In the example of FIG. 12, the exemplary SureTrim Company has no need to know about the access privileges granted inside store to the manager and the cashier. SureTrim can simply provide the fixture to the store pre-configure to allow access, for example, to all authenticated employees of SureTrim. If desired the system may be also configured to allow store managers to access the fixture.

As should be appreciated by those skilled in the art the matrix access mode is most powerful when used in combination with other modes, i.e., those described above and those described below.

In a fifth mode, a lock device may control access granted to a key device by way of an algorithm for the computation of codes based on one or more conditions and/or pseudorandom number generation. Such a state machine would be analogous to historic cryptographic systems such as the framed Enigma cipher device of early 20th century. In this mode, the code required to gain entry to the lock device shifts dynamically, either in response to new data being presented by the key, or simply by the advancement of a comprised state machine.

Here disablement of the privileges of the key device could be achieved by simply withholding from the key device some element of the algorithm or code sequence necessary to respond to a cipher request generated by the lock device. Referring to FIG. 10, in step 604 a lock device operating in this mode could require that the greeting provided by a key device in step 602 contain such a situationally generated code. Alternatively the lock device could prompt the key device to provide it after receipt of an accepted greeting, much in the way that steps 606 and 607 show such a request being made of the user of the key device.

It is significant that the code generation algorithm need not be contained wholly within either the lock device or the key device. The lock device could generate challenges for the key device in conjunction with network devices to which it communicate through a secure, encrypted, and/or authenticated channel provided by the key device. The key device could similarly generate responses to the lock devices cipher challenges in conjunction with the same or other network device with which it is in communication.

There are several advantages to such an arrangement. The first is the added defense against lock device tampering through electronic eavesdropping. Knowing the password which previously worked is here of no avail. To gain access to such a lock device requires that a key device be able to generate the next, different password that will be required. To do that, the key system must comprise an identical cipher state machine apparatus and hold the identical state machine settings.

However, a primary benefit of such complex arrangements is simply that through them a very high level of security and control can be maintained without requiring that the network be in direct communication with the lock devices. Nor is it required that any device communicate with the lock devices other than the key devices in the course of their ordinary business of seeking authorized access.

The five modes described above may be used in any combination. Indeed, it is highly advantageous that different combinations be applied to achieve different levels of security for various locks within a single facility, organization, or consortium of organizations. Further, these modes may be combined with virtually any other mode known within the start of the art of EAC systems. For instance, a lock device may be programmed to cease communicating whatsoever after a certain number of bad access attempts.

In a further aspect of the subject invention the decision whether to accept or deny an access request is based at least in part upon the provenance of the lock. One of the most striking problems in key management comes in multiple parties and multiple facilities handling of locked goods. Consider the luggage of passenger air travelers. Travelers would prefer that such luggage be locked to prevent tampering by airline employees, fellow travelers, or passersby. However, such luggage must be able to be opened for inspection by government agents such as transportation safety and customs inspectors. Today, the answer is to leave such luggage unlocked. However, in accordance with another aspect of the subject invention, a lock device could be programmed with provenance rule, i.e., a sequence of circumstances in which access may be granted. Such a rule would enable the lock device itself to enforce that proper procedures be followed by various parties having temporary custody of an item in transit. In the airline example, a luggage lock device could be programmed such that it always opens at the request of the owner of the bag, and that the owner may set the status of the lock to “flight secured” by issuing a special command from a key device. Once the status is set to “flight secured” the lock may not be opened by a transportation safety inspector or customs officer until the lock device has been checked in by, but not opened by, a passenger airline luggage agent. The lock device could be further programmed to open only once for each a transportation safety agent and a customs officer. The bag may thus be protected against being opened again by anyone other than the passenger until next set again to “flight secured” by the passenger. This is only one illustration of the types of rules possible and sequences possible, and the environments in which it may be used are obvious and manifold. Such capabilities may be of particular interest to those managing controlled substances, forensic evidence, medical specimens, research reagents, antiquities, prisoners, medical devices, toxic wastes, etc. In a further aspect of the subject invention the decision whether to accept or deny an access request is based at least in part upon the provenance of the key. Just as the access privileges of a lock may be altered by the sequence of events to which it is subjected, so may the access privileges of a key. Such rules may be contained in the programming of the key and thus be independent of the network with which the key device communicates. Applications of this embodiment could include single-use keys.

As noted above the key device 24 may take various forms. Referring to FIG. 4, the key device 24 can be a stand-alone unit. Such a dedicated component could be worn by a person on his/her wrist, or suspended from the person's neck by a lanyard, or on a card that can be carried in a wallet or purse, etc.

The key device 24 could also be part of any key bearing device. For example, the desired features may be incorporate into any suitable member, such as a cellular telephone, personal digital assistant (PDA), hand-held or laptop computer, or other device carried by a user. Similarly the key device could be attached to or incorporated into or attached to a vehicle, workstation, or other piece of equipment.

As noted above, lock devices can take many forms. The portability of the lock device 22 enables it to be used anywhere and then readily moved to another location for use thereat. Thus the system 20 is ideally suited to protect items from theft as it travels throughout the supply chain. It is highly advantageous that most or all of the locks in a given facility be lock devices compatible with a single key device carried by users. In this regard as will be appreciated by those skilled in the art from the discussion to follow, the system 20 can be used to form a relatively low cost access control system, since the lock devices to restrict access to an area need not be built (e.g. wired for power or data) into the structure housing the restricted area.

Moreover, the system 20 can also form a portion of a mobile commerce system, i.e. used for remote security of items. Thus it is also contemplated that lock devices take the form of physical locks on static structures. It is further contemplate that lock devices take the form of control interlocks, whereby the presentation of an authorized key device is necessary to change the state or setting of control device.

In a further embodiment, the secured interlock is a mechanical locking mechanism inhibiting free motion of a physical member. This could mean virtually any known mechanical locking system. This includes locks on static structures, such as door, drawer, cabinet, gate, and vault locks, and mechanical interlocks on industrial, medical, and military devices such as valves. It also includes locks on portable structures such as bicycle locks and such retail locking items as hard electronic article surveillance or benefit denial tags, product containers, or cable-secured alarm tags.

Referring to FIG. 4, lock devices can take the form of portable product protection items such as, but not limited to, hard tags, safers, spiders, boxes, cases, logistics totes, containers, vehicles, vehicle bodies, and other such structures. Examples include a secure parcel, a secure waste container, and a secure medical sample container. Thus the system 20 can be incorporated at every stage of retail or other supply chains.

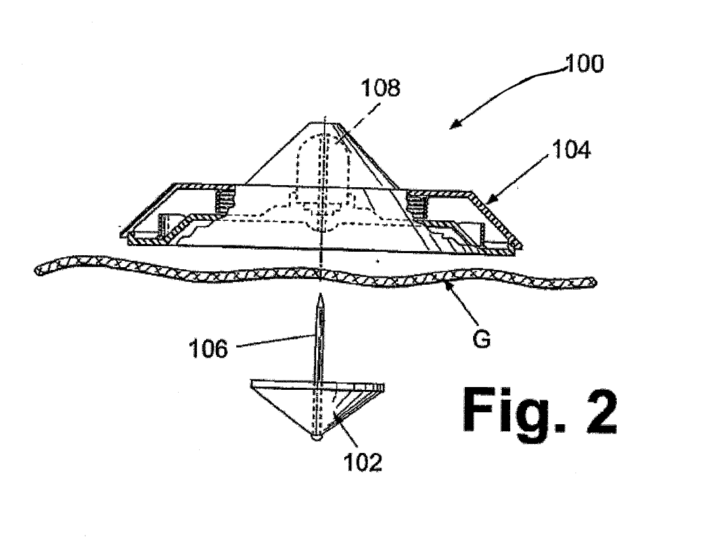

In FIG. 2 there is shown a hard tag 100 making use of a lock (not shown) constructed in accordance with this invention for protecting an article of merchandise, e.g., a garment, from theft. The hard tag 100 is similar in construction to that disclosed in U.S. Pat. No. 7,183,917 (Piccoli, et al.), entitled EAS/RFID Identification Hard Tags, which is assigned to the same assignee as this invention and whose disclosure is incorporated by reference herein. The hard tag 100 basically comprises two interlocking components 102 and 104 which include a lock constructed in accordance with the teachings of this invention. The component 102 includes a pin 106 that is arranged to pierce through the article to be protected, e.g., a garment G. The component 104 houses the lock of this invention and in particular the circuitry 32 (not visible in FIG. 2), the trigger mechanism 34 (also not visible in FIG. 2) and the latch 30 (also not visible in FIG. 2). The latch forms a portion of an activatable clutch 108 which is arranged to receive and trap the pin 106 of the component 102, thereby securing the two components 102 and 104 together on the garment. The hard tag is arranged to operate as follows. When the lock device's on-board circuitry receives a wireless signal from the electronic key 24 (FIG. 1) and that signal is decoded and determined to be a valid one, the trigger mechanism of the lock will be actuated thereby releasing a latch, which in turn releases the clutch 108 to enable the two components to be separated from each other and the hard tag to be removed from the garment.

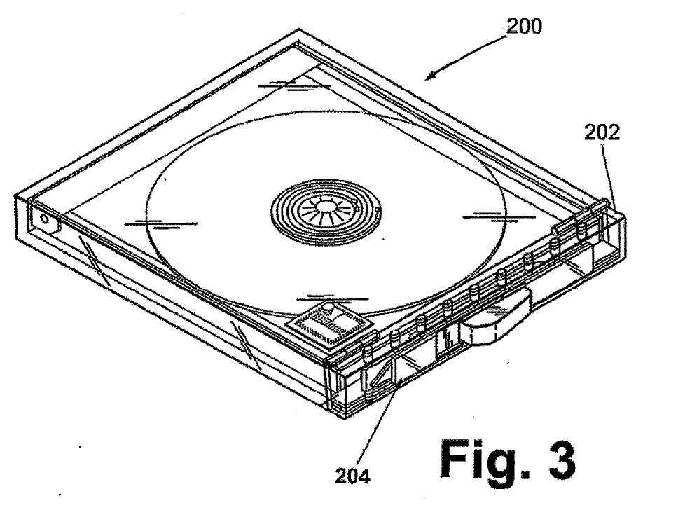

In FIG. 3 there is shown an exemplary “safer” or storage box 200 making use of a lock constructed in accordance with this invention for protecting an article of merchandise, e.g., a CD or DVD, from theft. The safer is similar in construction to that disclosed in copending U.S. patent application Ser. No. 11/154,252, filed on Jun. 16, 2005, entitled Self-Check System and Method For Protecting Digital Media, which is assigned to the same assignee as this invention and whose disclosure is incorporated by reference herein. That device basically comprises a case having a pivot able or hinged access door 202 at an end of the case. The door is arranged to be locked in the position shown in FIG. 3 by a lock 204. The lock 204 is constructed in accordance with this invention, but is not of the padlock type, like shown in FIG. 1, but rather comprises a pair of sleeves, a pair of ferromagnetic locking tongues and a locking bar. The sleeves and locking tongues together make up the latch mechanism to effect the movement of the bar. The bar holds the door in the closed position shown in FIG. 3 to prevent access to the CD or DVD located therein. The locking bar itself comprises a pair of notches that correspond to a pair of protrusions in the tongues. When the cover of the security box 200 is closed, and the locking bar slid downward through the sleeves, the protrusions are biased into the notches, thereby locking the cover in place. The lock 204, like the locks disclosed above, also includes the circuitry 32 (not visible in FIG. 3) and the trigger mechanism 34 (also not visible in FIG. 3). The lock 204 is arranged to operate as follows. When the lock's on-board circuitry receives a wireless signal from the electronic key 24 (FIG. 1) and that signal is decoded and determined to be a valid one, the trigger mechanism of the lock will be actuated thereby releasing a latch, which in turn causes a magnet (not shown) in the cover to move the ferromagnetic tongues toward the magnet, thereby disengaging from the notches and freeing the locking bar. The cover of the box can then be pivoted open to provide access to the CD/DVD.

Referring to FIG. 4, lock devices can also take the form of locks on static structures for product protection. Such structures include, but are not limited to, cabinets, lockers, drawers, display fixtures, and dispensing fixtures. An example would be a dispensing medical fixture (e.g. a robotic pharmacy device, and anesthesia machine.) Display fixtures may any number of forms, including but not limited to those which enclose articles for sale and those to which articles are secured by tethers.

Further, lock devices can take the form of locks on static structures designed to control human or vehicle ingress or egress, such as, but not limited to the group consisting of: a door, gate, or bar to prevent human transit; or a door, gate, bar, or treadle to prevent vehicle transit.

The system 20 can be used, for example, at a retail shelf level where customers can handle or manipulate an item but cannot remove it from the store location due to the item being electronically tethered to the store shelf. Without seeking the assistance of retail staff, customers using a key device could operate the lock device to liberate a secure article of merchandise. The data collection facet of the system could then be arranged to record this action as a valid sale and charge the customer's account accordingly. FIG. 6 depicts a key device suitable for such. The key device 24 incorporates an option user card reader 62. The card 61 could easily, among other options, be a staff identification card, a customer loyalty card, a smart money card, or a credit card.

Referring to FIG. 4A, lock devices can take the form of control interlocks on a variety of devices. Controls on many pieces of industrial and commercial equipment are often provided with key switches to prevent unauthorized tampering. For example, network servers and cash registers frequently have such key switches. The lock devices of the present invention can be incorporated into such items to provide a similar level of security and superior deployment, monitoring, and access privileges management.

Referring to FIG. 4A, such control interlocks take many forms, including but not limited to, bi-state and poly-state devices, continuous controls, and information flow controls.

A familiar example of bi-state controls are key power switches, such as those sometimes found on computer servers and on heating and ventilation equipment. Here locking is analogous to shutting off power, and unlocking to turning power on. Minor variations of the lock device internal design depicted in FIG. 1B would allow either of an electromechanical switch closure, an electronic switch, or a mechanical interlock on a user-actuated switch. Another example might be a cut-off valve on a water supply or hydraulic pressure system. Other examples include vehicle ignition switches, and switches on many non-residential lighting, heating, and ventilation systems, industrial, military, and medical systems, and on computing devices.

A familiar example of a poly-state control is the fan level of a household air conditioning unit. Such settings might be off, low, medium, and high. The key device could be used to toggle between these settings. Alternatively, the key device could cause the lock device to release a mechanical interlock on a user manipulated control.

This configuration can also be used in process interlocks. For example, on machinery that may cause injury or damage products during manufacture, a lock device may be used to require the authentication of the authority of a machine operator before the operator is allowed to change control parameters.

Another example is the use of locks to control the modes of mechanical systems. For instance, some retail dispensing devices are now available which have several modes of operation. In one mode, product is dispensed one at a time to a cashier with a key. In another, product is dispensed one at a time to anyone pulling on a lever. In a third mode, all contents of the dispenser are open for manipulation for purposes of rearranging (i.e. fronting) or restocking merchandise.

Similarly, a lock device could serve to control access to continuous control setting. This could be a mechanical control setting wherein the lock device fixes or frees the control to user manipulation. It could also be an electrical or electronic control either manipulated by the user through the key device or directly by the user when freed by the lock device.

Referring again to FIG. 4A, a lock device could also serve to control the flow of information in, out, or through a device. Non-limiting examples include encrypted media and media players, network portals, data collectors, etc., and the like where data is of a sensitive or critical nature and it is desirable to provide interlocks against unauthorized access. The data transmission could pass through the lock device to the key device. Alternatively, the data could flow directly from the source to the key once access been achieved through the key device/lock device dialogue. Of course, the lock device could simply unlock and enable data transmission of a device which has no data connection to either the lock or the key.

In accordance with a further aspect of the subject invention the lock device includes a locking status sensor. This provides the user valuable information regarding whether a locking device is properly secured, and regarding when the locking status changed.

In accordance with still a further aspect of the subject invention the lock includes an auxiliary sensor. Such a sensor could provide valuable information about, for example, the conditional of the lock or an adjacent area or apparatus.

In accordance with still a further aspect of the subject invention the decision whether to accept or deny access request made by the key is based at least in part upon the status of the auxiliary sensor.

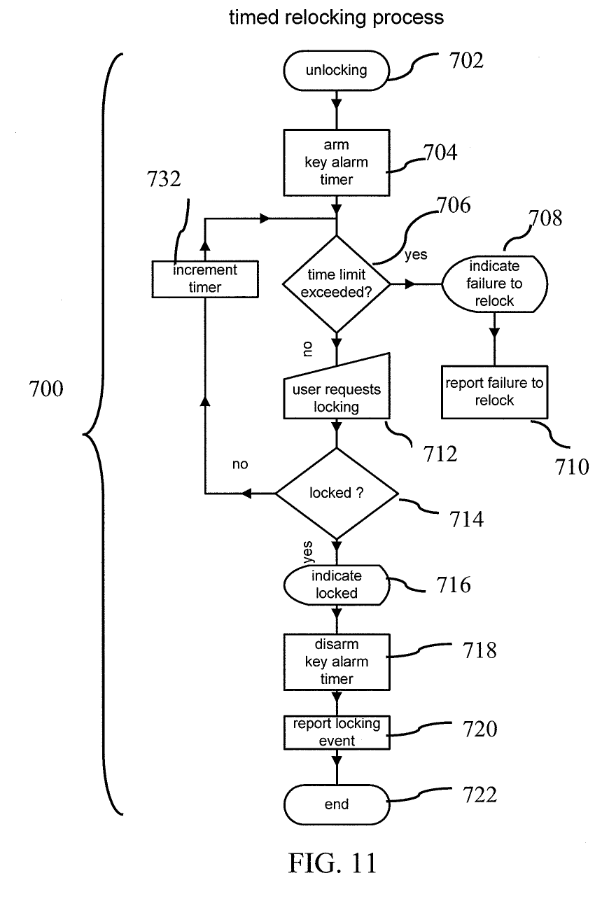

FIG. 11 is a schematic representation of a process for dynamically controlling the relocking of a lock device opened by a user of a key device in accordance with an aspect of the subject invention. The process 700 begins with an unlocking event 702 being recorded by a key device. The event triggers the starting of a timer 704 which is incremented 732 until a determination has been made that the lock device of the unlocking event 702 is confirmed to be relocked 714. The key device checks whether the time limit is exceeded 706 and, if so, indicates to the user this failure 708 and reports the event to the local database 710. Optionally, the user may enter a request to either effect locking or to confirm that the locking has been achieved 712. If locking is confirmed 716, the timer is disarmed 718, a status indication may be given and a report made of the locking event 720.

As noted above, the subject invention optionally provides a method for data collection previously unavailable in systems with standalone intelligent locks. The data collected from key devices, preferably wirelessly, can be used for a variety of logistics and compliance monitoring applications. For example, as mentioned, the subject invention enables users to create a trail of forensic quality data which can be used defensibly as a basis for making human resources decisions such as, but not limited to, discipline, dismissal, payment of bonuses, or promotion, as may be appropriate. Such data is also useful in monitoring logistics, e.g., the movement of locked items from one facility to another. Moreover, systems constructed in accordance with this invention are peculiarly suited for monitoring compliance of lock operations of goods traveling between different institutions, since physical locking and unlocking privileges can be transferred electronically, rather than requiring the physical distribution of physical or electronic keys. Data collection and analysis can insure that all parties are holding to their obligations with respect to the management of lock device secured articles, including who operated the lock devices, when, and where this occurred, and whether this was in compliance with prescribed procedures.

Thus, through the use of data collection and analysis, even if provenance rules or access privileges are not to deployed to locks, compliance to established procedures can be monitored. In other words, systems constructed in accordance with this invention provide for an honor system, in which explicit or particular control rules are not necessary. Rather, discipline is enforced through the reasonable expectation that lock device and key device activities are monitored. For example, in a retail establishment, all employees may be granted keys that open all locks in the establishment. The lock devices will not prevent any employee from opening them. However, since every use of a key identifies which key is use, on which lock, and when and where this occurred, employees will not generally disobey any guidelines about the proper use of key devices.

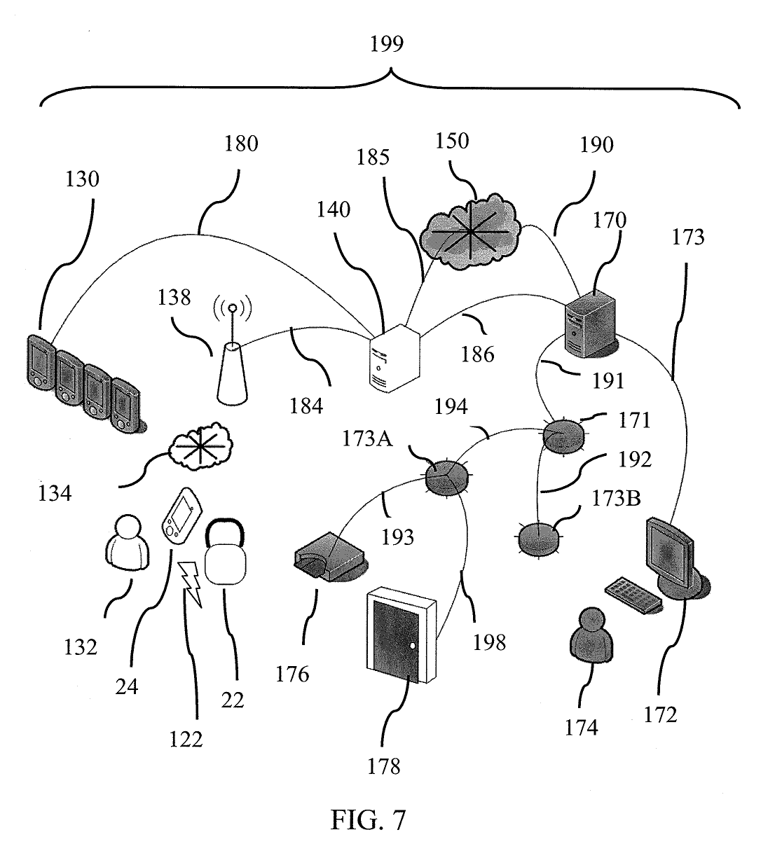

FIG. 7 is a schematic representation of another exemplary embodiment of an access control system in accordance with the subject invention implemented as a hybrid system 199 which includes previously discussed elements and elements of a prior art EAC system. As in FIG. 5, a user 132 has acquired a key device 24 from a registration station 130. Again the key device 24 may be used to open a lock device 22 via a wireless signal 122. Data related to this activity is transmitted by the key device 24 over the network 134 via hub 138. Various network components communicate via connections 173, 180, 184, 185, 186, 190, 191 using any appropriate protocols such as Ethernet. The privileges and activities of the user are buffered in a database 140 and may be transmitted to a remote site via wide area network 150, which may include Internet protocol connections. Unlike the system of FIG. 5, the access privileges are set by an electronic access control database 170 by a systems administrator 174 working at a terminal 172. The access control database 170 also communicates with a network of EAC devices including main controller 171 and terminal controllers 173A and 173B to control access to, for example, doorway 178 via badge reader 176, as well as other devices not shown. EAC network connections 192 and 194 may be Ethernet type or use a two-wire protocol such as RS485. The doorway and badge reader connections 198 and 193, respectively, are often, but not necessarily, of a proprietary or device-specific nature. In this scenario, the key device 24 may or may not provide an output compatible with the badge reader 176 thereby obviating the need for a separate access control card.

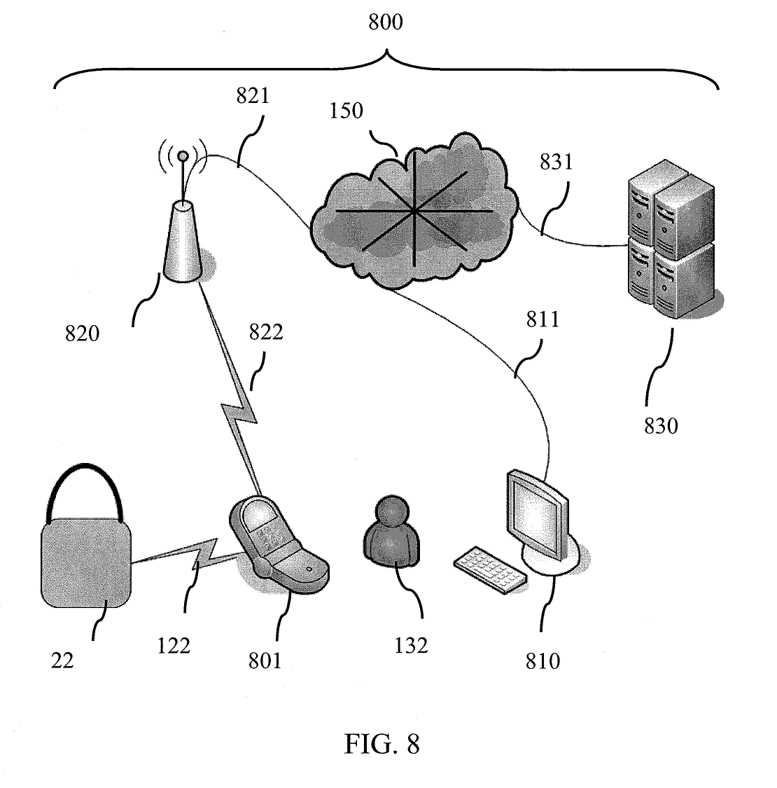

FIG. 8 is a schematic representation of another exemplary embodiment of the subject invention arranged for ubiquitous deployment of intelligent locks by consumers in a system 800 which utilizes cellular telephony. In this illustration, access privileges are controlled by the key user 132 through either a computer terminal 810 or a personal communication device 801, here depicted as a cell phone. The privileges are stored in a database 830.

In this example, the key device is incorporate inside the personal communication device 801. The personal communication device 801 communicates with the lock device 22 via a wireless protocol 122 as described above. Separately, the personal communication device 801 is in communicates with the network via a cellular telephony protocol connection 122. The lock device 22 may request to authenticate the request of the key device 800 by communicating through the key device 801 to a cellular communications tower 820 and a network 150 to the privileges database 830. The other connections of the system, 811, 821, and 831, are likely to be Internet or other standard network protocol connections.

This configuration of the invention is applicable to mobile commerce. For example it is contemplated that a person with a cell phone or other hand-held, wireless device can go to a dispensing or vending machine equipped with a lock device constructed in accordance with the teachings of this invention, to purchase an item in that machine by inputting appropriate information into the cell phone. The cell phone would then transmit the transaction data, e.g., purchase price, item purchased, etc., the credit card system of that person to debit his/her account. Once the transaction is approved, the credit card system would transmit an authorization signal to the cell phone, which in turn will produce and transmit an appropriate signal to the dispensing/vending machine to cause the lock device associated with the particular item to be dispensed to open and thereby release the item to the customer. Moreover, the circuitry in the lock can also be used to transmit information, e.g., status of inventory in the machine, etc., to the computer system of the dispensing machine operator.

This usage is differentiated from usual configurations of mobile commerce systems in that the dispensing/vending machine need have no independent means of contacting a network in order to effect a transaction. Further, optionally, the dispensing/vending machine would need no power source to operate the locking device. Hence, the dispensing/vending machine could be deployed by simply moving it into position without connecting to any power or data infrastructure and without providing it with a battery or solar power source.

As should be appreciated from the foregoing, the locks and locking system of this invention provide a very inexpensive and reliable universal device that can readily be used in place of virtually any conventional lock, including hard tag locks, door locks, padlocks, display fixture locks and dispenser locks. For example, in a retail business, locks can be installed at front doors, points of sale, security offices, “employee only” doors, stock rooms, loading docks, etc. This is accomplished through the use of a very inexpensive “tumbler” (e.g., an RF smart card chip or a new variation of a RFID chip), a reliable low-power actuated trigger and a potential energy storing latch in a passive lock that is operated and powered remotely from an electronic key. Moreover, the electronic key device of this invention can be a universal device for wirelessly communicating with the locks to open them and transmit and receive data from them and for communicating with any computer system. Thus, the subject invention enables one to create an overall system suitable for providing information in the form of a comprehensive log of who has/is opening the locks, including when, where under what circumstances and condition. Moreover, the system of this invention provides effective and efficient key management, so that authority to open the locks can be altered in real time. Thus, the system of this invention effectively solves many, if not all, of the key, key management, tumbler, tumbler setting, and use tracking issues inherent in prior art locking system. In view of the all of the foregoing, it should be appreciated that the systems of the subject invention provide for a modular deployment solution that can be adjusted to the economics of a customer's use.

Moreover, it should also be understood that the systems and devices of the subject invention constitute a radical departure in concept from the conventional idea of a lock system. In this regard, in conventional lock systems, the locking mechanism is typically the most expensive and elaborate portion of the locking system whereas the key, if a typical key with a toothed shank, is the most inexpensive part of the lock system. The cost of installing a plurality of these expensive locks, with associated keys, can easily exceed the budget of the owner. In addition, possession of a particular key determines who can gain access to the corresponding lock. Thus, managing of (and the unauthorized copying thereof) such keys also presents an even larger problem. In contrast, the subject invention reverses this entire paradigm since systems constructed in accordance with it can comprise one or a plurality of inexpensive passive locks with a single complex key device, or a limited number of such complex keys, all of which is/are not cost prohibitive to the business owner. Furthermore, from a security standpoint, possession of the key device is not determinative of controlling access to the locks because the software configuration of the key device is controlled by another entity, e.g., the business owner or headquarters, etc. If desired, the business owner or headquarters can immediately change (or implement a time limit on) the key device's software configuration, or the lock device's software configuration, thereby disabling the key device, or rendering it useless, regardless of who has possession of it.

The systems of this invention are arranged this way for both logistical and security reasons. The ubiquitous distribution of locks has been limited historically by the logistical concerns of either mechanical or intelligent locking solutions. Mechanical lock and key systems are laborious to maintain. While they are cheap to deploy, changing lock privileges dynamically is problematic. Conversely, while intelligent locks are easily managed dynamically, they are costly to deploy, largely due to the cost of deploying power and data to the locks.

The subject invention overcomes these limitations by providing lock devices which require no power or data installation. Instead, intelligent key devices carry the power to the keys and optionally provide a communications pathway by which the keys may contact central databases of access privileges. This resolves the primary logistical barriers to broader lock deployment.

For security purposes, it is best to provide the least number of ingress pathways to a lock device. Therefore, the lock device is wireless. There are preferably no keyways in which a thief may insert a tool, nor are electrical contacts provided by which a thief may apply unsafe voltages or currents in an attempt to defeat the interlocking device. Intelligent locking, however, invites the prospect of attempts by thieves to eavesdrop on code transmissions, or to electronically “turn the tumblers” until a valid code is found.

Compared to the EAS and video systems, which provide no physical security and only data subject to interpretation, the system of the present invention provides a new and unusual opportunity to both secure merchandise and to collect actionable data about activities within a facility. Compared with EAC systems, the systems of the present invention provide a unique opportunity to invert the EAC key/and reader price model, and thereby enables economical deployment of intelligent locks on an unprecedented scale. Compared to convention mechanical locks and keys, the systems of the subject invention provides a radical new way to manage key privileges and to track key usage along with the convenience of a single device per person to replace large numbers of mechanical keys that would be necessary to achieve the same functions.

While the invention has been described in detail and with reference to specific examples thereof, it will be apparent to one skilled in the art that various changes and modifications can be made therein without departing from the spirit and scope thereof. All of the prior art references and pending application identified in this application are incorporated by reference in their entireties.

What is claimed is:

1. A lock system comprising:
a remote actuating key device which comprises a portable member arranged to wirelessly transmit at least one radio frequency signal;
a passive lock device which comprises an actuatable trigger mechanism coupled to a control circuit, and wherein said control circuit is adapted to receive said at least one radio frequency signal for electrically powering said control circuit, and for determining if said signal is appropriate to unlock said lock device, said control circuit also generating a trigger signal if said signal is determined to be appropriate, said trigger signal being received by said trigger mechanism which activates said trigger mechanism to enable said lock device to be unlocked; and
a computer network, wherein said computer network and said key device are adapted to communicate via a wireless communications connection.

2. The lock system of claim 1 wherein said key device is further adapted to be enabled or disabled upon receipt of an appropriate communication received from said computer network.

3. The system of claim 1 wherein said key device further comprises a user interface, and wherein the key device is further arranged to require a user to enter a code to enable operation of said key device.

4. The system of claim 3 wherein said code required of the user is varied in accordance with an algorithm stored with said key device.

5. The system of claim 3 wherein said code required of the user is varied in accordance with an appropriate communication from said computer network.

6. The system of claim 3 wherein said computer network is further arranged to issue a communication to enable or disable said key device based upon an outcome of a dialogue between said key device and said computer network, and wherein said key device is arranged to facilitate said dialogue.

7. The system of claim 1 wherein said control circuit is further adapted to make inquiries of said key device whereby said lock device may authenticate an identity or authority of said key device in order to determine if said at least one signal is appropriate to unlock said lock device.

8. The system of claim 7 wherein said key device is further adapted to communicate with said computer network to obtain required responses to inquiries made by said lock device.

9. The system of claim 8 wherein said key device is further adapted to provide a communication channel whereby a dialogue may occur between said lock device and said computer network in which messages between said lock device and said computer network are relayed by said key device.

10. The system of claim 9 wherein said dialogue between said lock device and said computer network are encrypted for preventing interception by said key device or other message relaying devices.

11. The system of claim 1 wherein a code required of said key device to unlock said lock device is varied in accordance with an algorithm stored within said lock device.

12. The system of claim 11 wherein said algorithm makes use of a variable selected from the group consisting of:
(a) a date;
(b) a time;
(c) a provenance of said lock device;
(d) a provenance of said key device;
(e) a random number;
(f) a serial number of said lock device; and
(g) a serial number of said key device.

13. The system of claim 1 wherein said key device is further adapted to record when said lock device has been unlocked and to record when said lock device is later relocked, and to record an error or activate an alarm whenever a period of time between unlocking and locking of said locking device exceeds a predetermined period of time.

14. The system of claim 1 wherein said control circuit uses a matrix of permission criteria when determining if said signal is appropriate, said control circuit permitting a second key device to gain access to said lock device using a second signal different from said at least one radio frequency signal.

15. The system of claim 1 wherein said control circuit uses a provenance of said key device to determine if said signal is appropriate.

16. The system of claim 1 wherein said control circuit uses a provenance of said lock device to determine if said signal is appropriate.

17. A method of protecting a structure by use of a lock system comprising:
(a) coupling a passive lock device to a structure for protecting the structure;
(b) wirelessly transmitting at least one radio frequency signal from a remote actuating key device which includes a portable member;
(c) receiving said at least one radio frequency signal by a control circuit of said passive lock device for electrically powering said control circuit;
(c) determining, by said control circuit, if said at least one radio frequency signal is appropriate to unlock said passive lock device, and generating a trigger signal, by said control circuit, for receipt by an actuatable trigger mechanism coupled to said control circuit if said at least one radio frequency signal is determined appropriate and not generating said trigger signal if said at least one radio frequency signal is determined not appropriate by said control circuit;
(e) enabling said lock device to be unlocked by said trigger mechanism when said trigger signal is received by said trigger mechanism; and
(f) communicating, by said remote actuating key device, with a computer network via a wireless communication network.

18. The method of claim 17 wherein said key device is enabled or disabled upon receipt of an appropriate communication received from said computer network.

19. The method of claim 17 wherein said key device is enabled or disabled by a user who makes an entry of an appropriate code through a user interface of said key device.

20. The method of claim 18 wherein said code required of the user is varied in accordance with an algorithm stored with said key device.

21. The method of claim 18 wherein said code required of the user is varied in accordance with an appropriate communication from said computer network.

22. The method of claim 18 wherein said computer network issues a communication to enable or disable said key device based at least in part upon an outcome of a dialogue between said key device and said computer network, and wherein said key device is arranged to facilitate said dialogue.

23. The method of claim 17 wherein said control circuit makes inquiries of said key device whereby said lock device may authenticate an identity or authority of said key device in order to determine if said at least one signal is appropriate to unlock said lock device.

24. The method of claim 23 wherein said key device communicates with said computer network to obtain required responses to inquiries made by said lock device.

25. The method of claim 24 wherein said key device provides a communication channel and whereby a dialogue occurs between said lock device and said computer network in which messages between said lock device and said computer network are relayed by said key device.

26. The method claim 25 wherein said dialogue between said lock device and said computer network are encrypted for preventing interception by said key device or other message relaying devices.

27. The method of claim 17 wherein a code required of said key device to unlock said lock device is varied in accordance with an algorithm stored within said lock device.

28. The method of claim 27 wherein said algorithm makes use of a variable selected from the group consisting of:
(a) a date;
(b) a time;
(c) a provenance of said lock device;
(d) a provenance of said key device;
(e) a random number;
(f) a serial number of the lock device; and
(g) a serial number of said key device.

29. The method of claim 17 wherein said key device monitors the relocking of the lock device by:
(a) recording when said lock device has been unlocked;
(b) recording when said lock device is later relocked;
(c) recording an error or activating an alarm whenever a period of time between unlocking and locking of said locking device exceeds a predetermined period of time.

30. The method of claim 17 wherein said control circuit uses a matrix of permission criteria when determining if said signal is appropriate, said control circuit permitting a second key device to gain access to said lock device using a second signal different from said at least one radio frequency signal.

31. The method of claim 17 wherein said control circuit uses a provenance of said key device to determine if said signal is appropriate.

32. The method of claim 17 wherein said control circuit uses a provenance of said lock device to determine if said signal is appropriate.
